(19) United States
(12) Patent Application Publication
(10) Pub. No.: US 2024/0113837 A1
(43) Pub. Date: Apr. 4, 2024

(54) PRIORITIZATION OF SIDELINK REFERENCE SIGNALS

(71) Applicant: QUALCOMM Incorporated, San Diego, CA (US)

(72) Inventors: Seyedkianoush HOSSEINI, San Diego, CA (US); Alexandros MANOLAKOS, Escondido, CA (US)

(21) Appl. No.: 18/261,974

(22) PCT Filed: Feb. 9, 2022
(86) PCT No.: PCT/US22/15785

§ 371 Date: Jul. 18, 2023

(30) Foreign Application Priority Data
Mar. 29, 2021 (GR) 20210100197

(51) Int. Cl. H04L 5/00; H04W 72/25

(52) U.S. Cl. CPC H04L 5/0053; H04L 5/0048; H04W 72/25

(57) ABSTRACT

Aspects relate to prioritizing sidelink reference signals (SL-RSs) when the resources scheduled for two SL-RSs or corresponding reports generated based on SL-RSs at least partially overlap in the time domain. In some examples, the SL-RSs may be prioritized based on at least one prioritization rule associated with the SL-RSs. The prioritization rule(s) enable a wireless communication device to select one of the SL-RSs for communication of a corresponding sidelink communication (e.g., SL-RS or report) within the overlapping resources. The wireless communication device may further transmit a feedback indication indicating whether a sidelink communication was selected or dropped.

### CROSS-REFERENCE TO RELATED APPLICATIONS

The present application for patent claims priority to Greece Provisional Application no. 20210100197, filed Mar. 29, 2021, and assigned to the assignee hereof and hereby expressly incorporated by reference herein as if fully set forth below and for all applicable purposes.

### TECHNICAL FIELD

The technology discussed below relates generally to wireless communication networks, and more particularly, to prioritization between overlapping sidelink communications associated with sidelink reference signals.

### BACKGROUND

Wireless communication between devices may be facilitated by various network configurations. In one configuration, a cellular network may enable user equipment (UEs) to communicate with one another through signaling with a nearby base station or cell. Another wireless communication network configuration is a device to device (D2D) network in which UEs may signal one another directly, rather than via an intermediary base station or cell. For example, D2D communication networks may utilize sidelink signaling to facilitate the direct communication between UEs over a proximity service (ProSe) PC5 interface. In some sidelink network configurations, UEs may further communicate in a cellular network, generally under the control of a base station. Thus, the UEs may be configured for uplink and downlink signaling via a base station and further for sidelink signaling directly between the UEs without transmissions passing through the base station.

Sidelink communication may include the transmission and reception of sidelink reference signals. Examples of sidelink reference signals (SL-RSs) include a sidelink channel state information reference signal (CSI-RS), sidelink positioning reference signal (PRS), and a sidelink sounding reference signal (SRS). Sidelink reference signal transmission may be periodic, semi-persistent, or aperiodic and may be scheduled by a base station or a scheduling sidelink device (e.g., a UE).

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method for wireless communication at a wireless communication device in a wireless communication network is disclosed. The method includes receiving a first request for communication of a first sidelink communication corresponding to a first sidelink reference signal (SL-RS) or a first report generated based on the first SL-RS within a first set of resources. The first set of resources at least partially overlaps in a time domain with a second set of resources indicated in a second request for communication of a second sidelink communication corresponding to a second SL-RS or a second report generated based on the second SL-RS. The method further includes selecting the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS.

Another example provides a wireless communication device in a wireless communication network. The wireless communication device includes a transceiver, a memory, and a processor coupled to the transceiver and the memory. The processor and the memory are configured to receive a first request for communication of a first sidelink communication corresponding to a first sidelink reference signal (SL-RS) or a first report generated based on the first SL-RS within a first set of resources. The first set of resources at least partially overlaps in a time domain with a second set of resources indicated in a second request for communication of a second sidelink communication corresponding to a second SL-RS or a second report generated based on the second SL-RS. The processor and the memory are further configured to select the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second sidelink SL-RS.

Another example provides a wireless communication device. The wireless communication device includes means for receiving a first request for communication of a first sidelink communication corresponding to a first sidelink reference signal (SL-RS) or a first report generated based on the first SL-RS within a first set of resources. The first set of resources at least partially overlaps in a time domain with a second set of resources indicated in a second request for communication of a second sidelink communication corresponding to a second SL-RS or a second report generated based on the second SL-RS. The wireless communication device further includes means for selecting the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS.

These and other aspects will become more fully understood upon a review of the detailed description, which follows. Other aspects, features, and embodiments will become apparent to those of ordinary skill in the art, upon reviewing the following description of specific, exemplary embodiments of in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a frame structure for use in a wireless communication network according to some aspects.

FIG. 3 is a diagram illustrating an example of a wireless communication network employing sidelink communication according to some aspects.

FIG. 4 is a diagram illustrating an example of a wireless communication network employing sidelink relaying according to some aspects.

FIG. 5 is a diagram illustrating an example of sidelink resources according to some aspects.

FIGS. 6A-6C are signaling diagrams illustrating exemplary signaling for sidelink channel state information estimation and reporting according to some aspects.

FIG. 7 is a diagram illustrating exemplary sidelink reference signal (SL-RS) scheduled resources according to some aspects.

FIG. 8 is a diagram illustrating other exemplary SL-RS scheduled resources according to some aspects.

FIG. 9 is a signaling diagram illustrating exemplary signaling for SL-RS prioritization according to some aspects.

FIGS. 10A and 10B are diagrams illustrating exemplary overlapping SL-RS scheduled resources according to some aspects.

FIG. 11 is a signaling diagram illustrating exemplary signaling for SL-RS prioritization and reporting according to some aspects.

FIG. 12 is a block diagram illustrating an example of a hardware implementation for a wireless communication device employing a processing system according to some aspects.

FIG. 13 is a flow chart of an exemplary method for SL-RS prioritization according to some aspects.

FIG. 14 is a flow chart of another exemplary method for SL-RS prioritization according to some aspects.

FIG. 15 is a flow chart of another exemplary method for SL-RS prioritization according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosure relate to prioritizing sidelink reference signals (SL-RS) when the resources scheduled for two or more SL-RSs or corresponding reports generated based on the SL-RSs at least partially overlap in the time domain. In some examples, the SL-RSs may be prioritized based on at least one prioritization rule associated with the SL-RSs. The prioritization rule(s) enable a wireless communication device (e.g., a UE) to select one of the SL-RSs for communication of the selected SL-RS or corresponding report within the overlapping resources. In some examples, the UE may communicate (e.g., transmit or receive) the selected SL-RS within the overlapping resources and may further communicate the selected SL-RS and/or another SL-RS within non-overlapping resources.

In some examples, the UE performing prioritization may inform the other devices (e.g., other UE(s) and/or a base station) associated with non-selected sidelink communications (e.g., non-selected SL-RSs and/or corresponding reports) that the non-selected sidelink communications were dropped. For example, the prioritizing UE may transmit a feedback indication to the other devices associated with non-selected sidelink communications including a negative acknowledgment (NACK) of the associated request. In some examples, the prioritizing UE may further transmit a feedback indication to the device (e.g., UE or base station) associated with the selected sidelink communication (e.g., selected SL-RS and/or corresponding report), including an acknowledgement (ACK) of the associated request.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

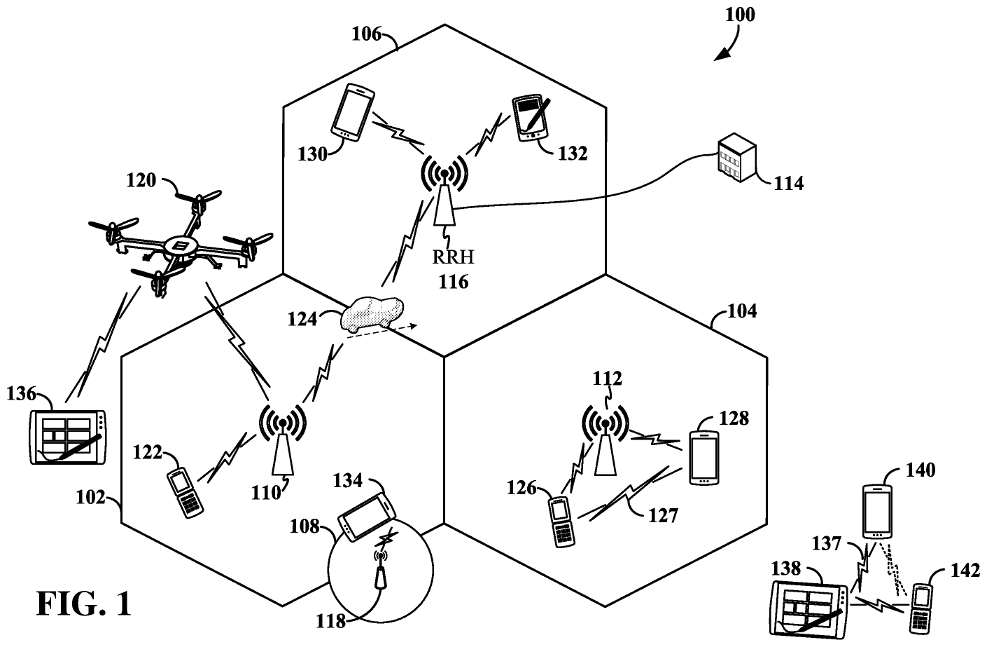

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 100, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In some examples, a RAN 100 may enable mobility and handovers (i.e., the transfer of a UE's connection from one radio channel to another). For example, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

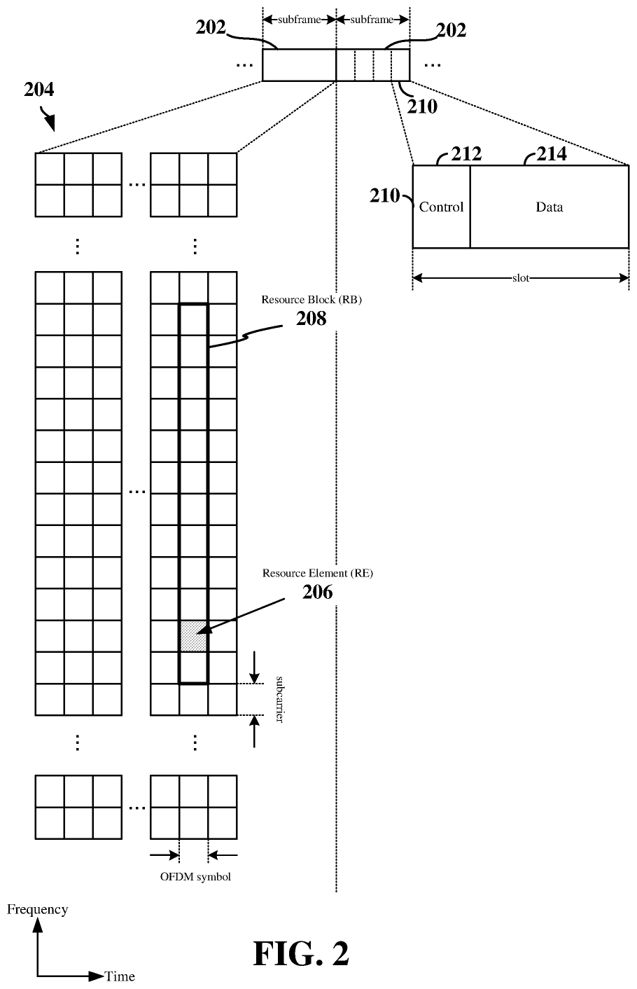

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an exemplary subframe 202 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 208 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 206 within one or more sub-bands or bandwidth parts (BWPs). Thus, a UE generally utilizes only a subset of the resource grid 204. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 12 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The structure illustrated in FIG. 2 is merely exemplary in nature, and different slot structures may be utilized, and may include one or more of each of the control region(s) and data region(s).

Although not illustrated in FIG. 2, the various REs 206 within a RB 208 may be scheduled to carry one or more physical channels, including control channels, shared channels, data channels, etc. Other REs 206 within the RB 208 may also carry pilots or reference signals. These pilots or reference signals may provide for a receiving device to perform channel estimation of the corresponding channel, which may enable coherent demodulation/detection of the control and/or data channels within the RB 208.

In some examples, the slot 210 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 206 (e.g., within the control region 212) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 206 (e.g., in the control region 212 or the data region 214) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 20, 80, or 120 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 206 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 206 (e.g., within the data region 214) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 206 within the data region 214 may be configured to carry other signals, such as one or more SIBs and DMRSs.

In an example of sidelink communication over a sidelink carrier via a PC5 interface, the control region 212 of the slot 210 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 214 of the slot 210 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 206 within slot 210. For example, HARQ feedback information may be transmitted in a physical sidelink feedback channel (PSFCH) within the slot 210 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 210.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

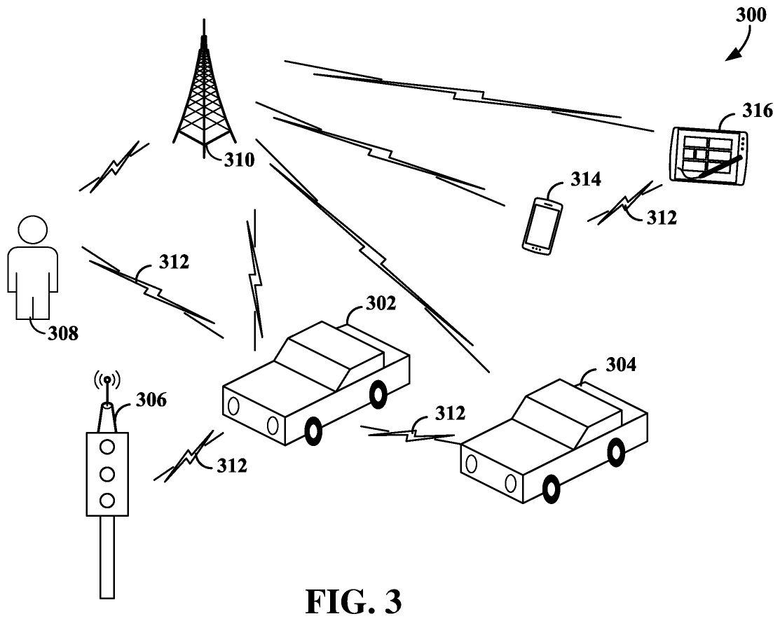

FIG. 3 illustrates an example of a wireless communication network 300 configured to support D2D or sidelink communication. In some examples, sidelink communication may include V2X communication. V2X communication involves the wireless exchange of information directly between not only vehicles (e.g., vehicles 302 and 304) themselves, but also directly between vehicles 302/304 and infrastructure (e.g., roadside units (RSUs) 306), such as streetlights, buildings, traffic cameras, tollbooths or other stationary objects, vehicles 302/304 and pedestrians 308, and vehicles 302/304 and wireless communication networks (e.g., base station 310). In some examples, V2X communication may be implemented in accordance with the New Radio (NR) cellular V2X standard defined by 3GPP, Release 16, or other suitable standard.

V2X communication enables vehicles 302 and 304 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 302 and 304 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 308 may be utilized to trigger a warning sound, vibration, flashing light, etc., in case of imminent danger.

The sidelink communication between vehicle-UEs (V-UEs) 302 and 304 or between a V-UE 302 or 304 and either an RSU 306 or a pedestrian-UE (P-UE) 308 may occur over a sidelink 312 utilizing a proximity service (ProSe) PC5 interface. In various aspects of the disclosure, the PC5 interface may further be utilized to support D2D sidelink 312 communication in other proximity use cases. Examples of other proximity use cases may include public safety or commercial (e.g., entertainment, education, office, medical, and/or interactive) based proximity services. In the example shown in FIG. 3, ProSe communication may further occur between UEs 314 and 316.

ProSe communication may support different operational scenarios, such as in-coverage, out-of-coverage, and partial coverage. Out-of-coverage refers to a scenario in which UEs (e.g., V-UEs 302 and 304 and P-UE 308) are outside of the coverage area of a base station (e.g., base station 310), but each are still configured for ProSe communication. Partial coverage refers to a scenario in which some of the UEs (e.g., V-UE 304) are outside of the coverage area of the base station 310, while other UEs (e.g., V-UE 302 and P-UE 308) are in communication with the base station 310. In-coverage refers to a scenario in which UEs (e.g., UEs 314 and 316) are in communication with the base station 310 (e.g., gNB) via a Uu (e.g., cellular interface) connection to receive ProSe service authorization and provisioning information to support ProSe operations.

To facilitate D2D sidelink communication between, for example, UEs 314 and 316 over the sidelink 312, the UEs 314 and 316 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 312. For example, the discovery signal may be utilized by the UE 316 to measure the signal strength and channel status of a potential sidelink (e.g., sidelink 312) with another UE (e.g., UE 314). The UE 316 may utilize the measurement results to select a UE (e.g., UE 314) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. A radio resource control (RRC) configuration of the resource pools may be either pre-configured (e.g., a factory setting on the UE determined, for example, by sidelink standards or specifications) or configured by a base station (e.g., base station 310).

In addition, there may be two main resource allocation modes of operation for sidelink (e.g., PC5) communications. In a first mode, Mode 1, a base station (e.g., gNB) 310 may allocate resources to sidelink devices (e.g., V2X devices or other sidelink devices) for sidelink communication between the sidelink devices in various manners. For example, the base station 310 may allocate sidelink resources dynamically (e.g., a dynamic grant) to sidelink devices, in response to requests for sidelink resources from the sidelink devices. The base station 310 may further activate preconfigured sidelink grants (e.g., configured grants) for sidelink communication among the sidelink devices. In Mode 1, sidelink feedback may be reported back to the base station 310 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may also be transmitted on the PSCCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

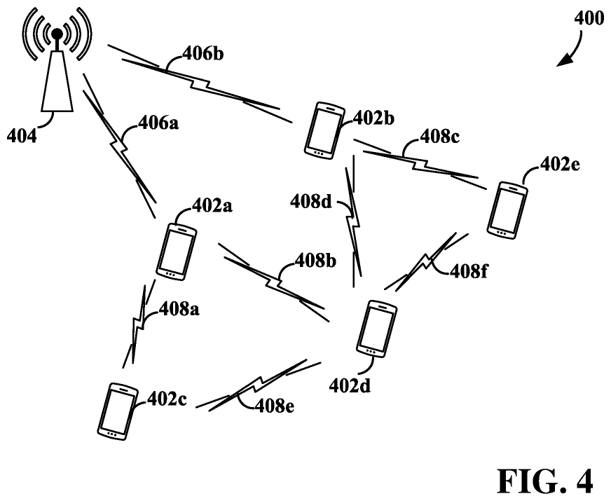

FIG. 4 is a diagram illustrating an exemplary wireless communication network 400 employing D2D or sidelink relaying. The wireless communication network 400 may correspond, for example, to the RAN 100 illustrated in FIG. 1 or the wireless communication network 300 shown in FIG. 3. The wireless communication network 400 may include a base station (e.g., an eNB or gNB) 404 in wireless communication with one or more wireless communication devices (e.g., UEs) 402a, 402b, 402c, 402d, and 402e. In the example shown in FIG. 4, the base station 404 may communicate with at least UEs 402a and 402b via a respective Uu wireless communication link 406a and 406b. In some examples, the base station 404 may further have a Uu link with one or more of remote UEs (e.g., UEs 402c, 402d, and/or 402e). Each of the Uu wireless communication links 406a and 406b may utilize a sub-6 GHz carrier frequency or a mmWave carrier frequency. In some examples, one or more UEs (e.g., UEs 402c, 402d, and 402d) may not have a Uu connection with the base station 404.

In addition, respective D2D relay links (sidelinks) 408a-408f may be established between various UEs to enable relaying of information between the base station 404 and one or more remote UEs, such as UEs 402c-402e, or between a remote UE (e.g., UE 402e) and a destination UE (e.g., UE 402c). For example, relay link 408a may be established between UE 402c and UE 402a, relay link 408b may be established between UE 402d and UE 402a, relay link 408c may be established between UE 402e and 402b, relay link 408d may be established between UE 402d and UE 402b, relay link 408e may be established between UE 402c and UE 402d, and relay link 408f may be established between UE 402d and UE 402e. Each relay link 408a-408f may utilize decode and forward (DF) relaying, amplify and forward (AF) relaying, or compress and forward (CF) relaying. For DF relaying, HARQ feedback may be provided from the receiving device to the transmitting device. The sidelink communication over the relay links 408a-408d may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications.

The relay links 408a-408f may be established due to, for example, distance or signal blocking between the base station 404 (or destination UE) and a remote UE (e.g., UE 402e), weak receiving capability of the remote UE, low transmission power of the remote UE, limited battery capacity of the remote UE, and/or to improve link diversity. Thus, the relay links 408a-408f may enable communication between the base station 404 and a remote UE (e.g., UE 402e) to be relayed via one or more relay UEs (e.g., UEs 402a-402d) over Uu wireless communication links (e.g., the Uu interface) 406a and 406b and relay links (e.g., sidelinks) 408a-408f. In other examples, the relay links 408a-408f may enable sidelink communication to be relayed between remote UE 402e and another destination UE (e.g., UE 402c) over various relay links.

In some examples, a common carrier may be shared between the sidelinks 408a-408f and Uu links 406a and 406b, such that resources on the common carrier may be allocated for both sidelink communication between wireless communication devices 402a-402e and cellular communication (e.g., uplink and downlink communication) between the wireless communication devices 402a-402e and the base station 404. For example, the wireless communication network 400 may be configured to support a Mode 1 sidelink network in which resources for both sidelink and cellular communication are scheduled by the base station 404. In other examples in which Mode 2 sidelink is implemented on the sidelinks 408a-408f, the wireless communication devices 402a-402e may autonomously select sidelink resources (e.g., from one or more frequency bands or sub-bands designated for sidelink communication) for communication therebetween. In some examples, the remote UE 402e or other scheduling entity (e.g., UE 402a) may select the sidelink resources for relaying communication between the remote UE 402e and other relay UEs 402a-402d. In examples in which the relay communication is between the remote UE 402e and a destination UE (e.g., UE 402c), the sidelink resources for relaying may be selected by the base station 404 in a Mode 1 configuration or by the remote UE 402e or the destination UE 402c in a Mode 2 configuration.

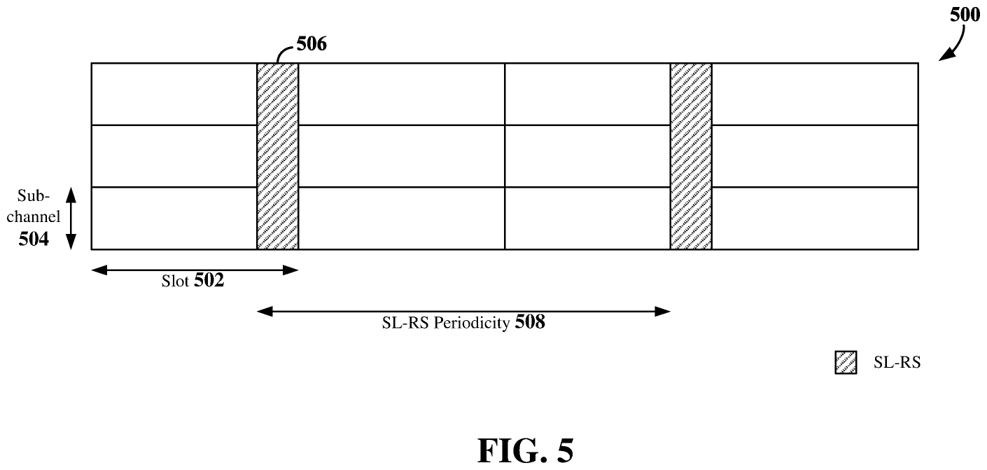

FIG. 5 is a diagram illustrating an example of sidelink resources 500 according to some aspects. The sidelink resources may be utilized, for example, in a V2X or other D2D network implementing sidelink, such as the wireless communication networks shown in FIGS. 1, 3, and/or 4. In the example shown in FIG. 5, time is in the horizontal direction with units of slots 502 (e.g., OFDM symbols); and frequency is in the vertical direction with units of sub-channels 504 of a carrier bandwidth. Each sub-channel may include a configurable number of PRBs (e.g., 10, 15, 20, 25, 50, 55, or 100 PRBs).

Each slot 502 may include, for example, fourteen symbols that may be used for sidelink communication. However, it should be understood that sidelink communication can be configured to occupy fewer than fourteen symbols in a slot, and the disclosure is not limited to any particular number of symbols.

On a per resource pool basis, a set of sidelink reference signal (SL-RS) resources 506, such as a set of symbols in a sidelink slot 502 or a full sidelink slot 502 may be allocated for the transmission of SL-RSs. SL-RSs may include, but are not limited to, a sidelink CSI-RS, a sidelink SRS, and/or a sidelink positioning reference signal (PRS). In the example shown in FIG. 5, the SL-RS resources 506 include a set of one or more symbols in a slot 502. The SL-RS resources 506 may be narrowband (e.g., per sub-channel) or wide-band (e.g., over all sub-channels), the latter being illustrated. The SL-RS transmission may be independent of any data transmission and may be periodic, semi-persistent, or aperiodic. In examples in which the SL-RS transmission is periodic, a SL-RS periodicity 508 between consecutive SL-RS transmissions of a transmitting device (e.g., a Tx sidelink device) may be defined. For example, the SL-RS periodicity 508 may be defined via semi-persistent scheduling (SPS) signaling, radio resource control (RRC) signaling, a medium access control (MAC) control element (MAC-CE), or other suitable signaling. In some examples, the Tx sidelink device may be a remote UE or a relay UE in a relay configuration. In this example, a report, such as a sidelink CSI report, may be generated and transmitted by the remote UE or relay UE, as described further below.

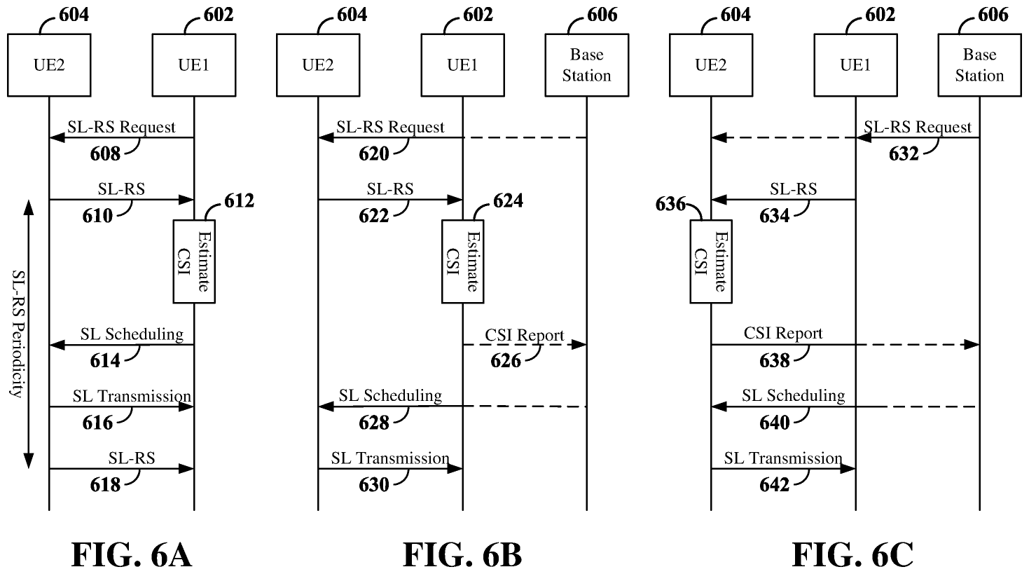

FIGS. 6A-6C are signaling diagrams illustrating exemplary signaling for sidelink channel state information estimation and reporting between UEs 602 and 604 and/or between UEs 602 and 604 and a base station 606 according to some aspects. The base station 606 may be any of the base stations (e.g., gNB, eNB, etc.) or scheduling entities shown in FIGS. 1, 3, and/or 4. The UEs 602 and 604 may be any of the UEs or scheduled entities shown in FIGS. 1, 3, and/or 4.

In the example shown in FIG. 6A, a scheduling UE (e.g., UE 604) is shown in communication with a scheduled UE (e.g., UE 602) over a sidelink. At 608, the scheduling UE 604 may allocate periodic resources (e.g., time-frequency resources) for the transmission of a sidelink reference signal (SL-RS) from the scheduled UE 602 to the scheduling UE 604. The scheduling UE 604 then transmits a request to the scheduled UE 602 including the allocated periodic SL-RS resources. In some examples, the SL-RS resources may be configured via an RRC message, and the SL-RS request may be included within SCI or a MAC-CE activating the periodic SL-RS resources.

At 610, the scheduled UE 602 transmits a SL-RS to the scheduling UE 604 in accordance with the periodic SL-RS resources indicated in the SL-RS request. In some examples, the SL-RS may include a sidelink CSI-RS. At 612, the scheduling UE 604 utilizes the SL-RS to estimate channel state information (CSI) indicating the quality of a channel between the scheduling UE 604 and the scheduled UE 602 over the sidelink. For example, the CSI may indicate a modulation and coding scheme (MCS) to utilize for sidelink transmissions between the UEs 602 and 604. The CSI may further indicate a rank, precoding matrix, and column of the precoding matrix to utilize for sidelink transmissions.

At 614, the scheduling UE 604 generates and transmits sidelink scheduling information to the scheduled UE 602 based on the CSI. At 616, the scheduled UE 602 utilizes the scheduling information to transmit a sidelink transmission (e.g., PSSCH) to the scheduling UE 604. At 618, the scheduled UE 602 transmits a new SL-RS to the scheduling UE 604 based on the SL-RS periodicity indicated in the SL-RS request.

In the example shown in FIG. 6B, a relay UE (e.g., UE1 602) is shown in communication with a remote UE (e.g., UE2 604) over a sidelink and with the base station 606 over a Uu link. The base station 606 (in Mode 1) or relay UE 602 (in Mode 2) may allocate aperiodic resources (e.g., time-frequency resources) for the transmission of a sidelink reference signal (SL-RS) from the remote UE 604 to the relay UE 602. The base station 606 (in Mode 1) may further allocate aperiodic resources for the transmission of a report (e.g., CSI report) from the relay UE 602 to the base station 606. The report may be generated, for example, based on the SL-RS.

In examples in which the base station 606 allocates the resources for the SL-RS and/or the report, at 620, the base station 606 may transmit a request to the relay UE 602 including the allocated aperiodic resources for the SL-RS and/or report. In some examples, the request may include report information for the relay UE 602 to generate and transmit the report (e.g., CSI report) to the base station 606. The report information may include, for example, a report type (e.g., type of CSI information included in a CSI report or frequencies over which the CSI information is obtained) and an allocation of report resources (e.g., time-frequency resources) over which the report may be transmitted from the relay UE 602 to the base station 606.

The relay UE 602 then transmits a request to the remote UE 604 including the allocated aperiodic resources. In examples in which the base station 606 allocates the aperiodic resources for the SL-RS, the relay UE 602 may forward the request received from the base station 606 to the remote UE 604 over a sidelink therebetween. In some examples, the SL-RS resources and/or report resources may be configured via an RRC message, and the request may be included within DCI, SCI, and/or a MAC-CE triggering the SL-RS resources and/or report resources.

At 622, the remote UE 604 transmits a SL-RS to the relay UE 602 in accordance with the aperiodic SL-RS resources indicated in the request. In some examples, the SL-RS may include a sidelink CSI-RS. At 624, the relay UE 602 utilizes the SL-RS to estimate channel state information (CSI) indicating the quality of a channel between the relay UE 602 and the remote UE 604 over the sidelink. For example, the CSI may indicate a modulation and coding scheme (MCS) to utilize for sidelink transmissions between the UEs 602 and 604. The CSI may further indicate a rank, precoding matrix, and column of the precoding matrix to utilize for sidelink transmissions. At 626, the relay UE 602 may optionally generate and transmit a CSI report to the base station 606 based on the estimated CSI. For example, the CSI report may include a channel quality indicator (CQI) indicating the MCS, a rank indicator (RI) indicating the rank, a precoding matrix indicator (PMI) indicating the precoding matrix, and a strongest layer indicator (SLI) indicating the column of the precoding matrix.

At 628, the base station 606 (in Mode 1) or the relay UE 602 (in Mode 2) generates and transmits sidelink scheduling information to the remote UE 604 based on the CSI. At 630, the remote UE 604 utilizes the scheduling information to transmit a sidelink transmission (e.g., PSSCH) to the relay UE 602.

In the example shown in FIG. 6C, a relay UE (e.g., UE1 602) is shown in communication with a remote UE (e.g., UE2 694) over a sidelink and with the base station 606 over a Uu link. At 632, the base station 606 may allocate aperiodic resources (e.g., time-frequency resources) for the transmission of a sidelink reference signal (SL-RS) from the relay UE 602 to the remote UE 604 and/or the transmission of a report (e.g., CSI report) generated based on the SL-RS from the remote UE 604 to the relay UE 602 and/or base station 606. The base station 606 then transmits a request to the relay UE 602 including the allocated aperiodic SL-RS resources. In some examples, the SL-RS request may further include report information for the remote UE 604 to generate and transmit a report (e.g., CSI report) to the relay UE 602 or base station 606. The report information may include, for example, a report type (e.g., type of CSI information included in a CSI report or frequencies over which the CSI information is obtained) and an allocation of report resources (e.g., time-frequency resources) over which the report may be transmitted from the remote UE 602 to the relay UE 604 or base station 606. In this example, the relay UE 602 may further forward the request to the remote UE 604. In some examples, the SL-RS resources and/or report resources may be configured via an RRC message, and the SL-RS request may be included within DCI, SCI, and/or a MAC-CE triggering the SL-RS resources and/or report resources.

At 634, the relay UE 602 transmits a SL-RS to the remote UE 604 in accordance with the aperiodic SL-RS resources indicated in the SL-RS request. In some examples, the SL-RS may include a sidelink CSI-RS. At 636, the remote UE 604 utilizes the SL-RS to estimate channel state information (CSI) indicating the quality of a channel between the relay UE 602 and the remote UE 604 over the sidelink. For example, the CSI may indicate a modulation and coding scheme (MCS) to utilize for sidelink transmissions between the UEs 602 and 604. The CSI may further indicate a rank, precoding matrix, and column of the precoding matrix to utilize for sidelink transmissions. At 638, the remote UE 604 generates and transmits a CSI report to the relay UE 602 or base station 606 (e.g., via the relay UE 602) based on the estimated CSI. For example, the CSI report may include a channel quality indicator (CQI) indicating the MCS, a rank indicator (RI) indicating the rank, a precoding matrix indicator (PMI) indicating the precoding matrix, and a strongest layer indicator (SLI) indicating the column of the precoding matrix.

At 640, the base station 606 (in Mode 1) or the relay UE 602 (in Mode 2) generates and transmits sidelink scheduling information to the remote UE 604 based on the CSI. At 642, the remote UE 604 utilizes the scheduling information to transmit a sidelink transmission (e.g., PSSCH) to the relay UE 602.

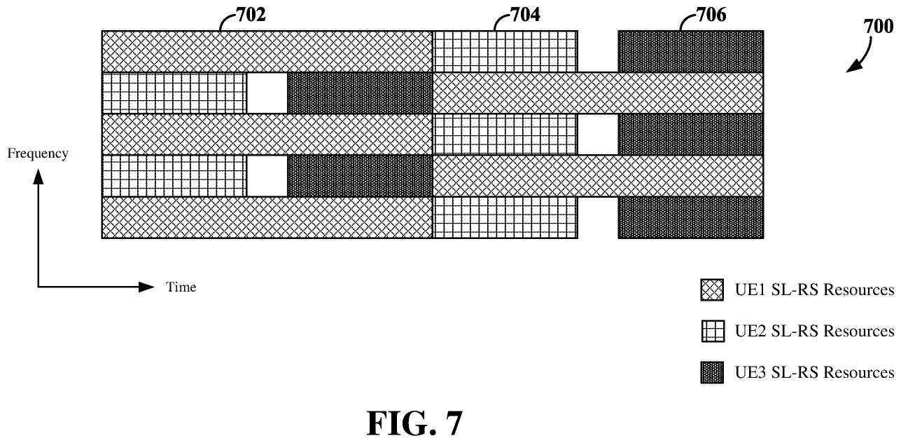

FIG. 7 is a diagram illustrating exemplary sidelink reference signal (SL-RS) scheduled resources 700 according to some aspects. In the example shown in FIG. 7, time is in the vertical direction; and frequency is in the horizontal direction. The SL-RS scheduled resources 700 may be scheduled, for example, by a base station in a Mode 1 configuration.

In the example shown in FIG. 7, SL-RS resources are scheduled for three UEs (UE1, UE2, and UE3). For example, a first set of SL-RS resources 702 may be scheduled for UE1, a second set of SL-RS resources 704 may be scheduled for UE2, and a third set of SL-RS resources 706 may be scheduled for UE3. Each set of SL-RS resources 702, 704, and 706 may be aperiodic SL-RS resources, semi-persistent SL-RS resources, or periodic SL-RS resources. To ensure the quality of sidelink channel estimation, the base station may schedule the SL-RS resources 702, 704, and 706 to avoid collisions therebetween. In addition, the base station may implement a hopping pattern for each of the SL-RS resources 702, 704, and 706 to improve CSI estimation over time.

In a sidelink relay network, such as the relay network shown in FIG. 4, the base station may provide for an orthogonal allocation of SL-RS resources 702, 704, and 706 across relays to avoid inter-relay interference. For example, UE3 may correspond to UE 402e in FIG. 4, whereas UE1 and UE2 may correspond to UEs 402c and 402d, respectively. As shown in FIG. 7, SL-RS resources 702 allocated to UE 402e via relay UE 402b may be orthogonal to SL-RS resources 704 and 706 allocated to UEs 402c and 402d via relay UE 402a. By allocating SL-RS resources 702, 704, and 706 to remote UEs 402d, 402e, and 402c via relay UEs 402a and 402b, inter-UE interference may be avoided. In some examples, the base station may apply SL-RS resource re-use across distant remote UEs. A similar resource allocation configuration may further be utilized for reports (e.g., CSI reports) generated based on SL-RSs.

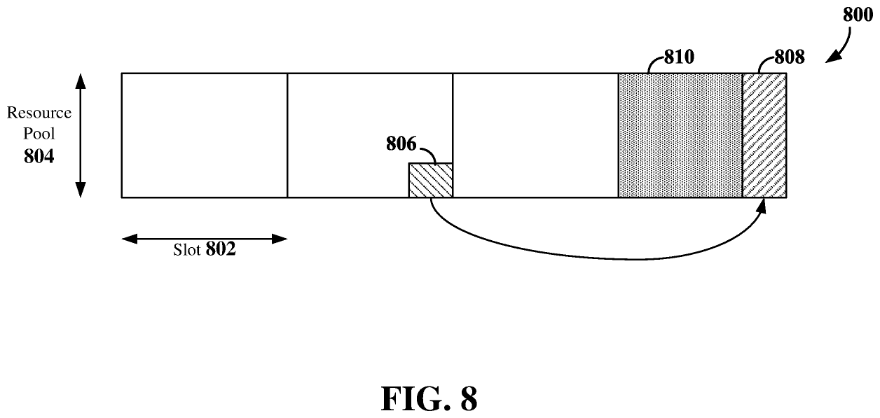

FIG. 8 is a diagram 800 illustrating other exemplary SL-RS scheduled resources according to some aspects. In the example shown in FIG. 8, time is in the horizontal direction with units of slots 802 (e.g., OFDM symbols); and frequency representing a resource pool 804 is in the vertical direction. The SL-RS scheduled resources may be scheduled, for example, by a scheduling UE (e.g., a relay UE or destination UE) in a Mode 2 configuration.

In the example shown in FIG. 8, the scheduling UE may schedule a set of SL-RS resources 808 (e.g., wide-band resources including a plurality of sub-channels in the resource pool 804) for a scheduled UE (e.g., UE1, which may be a remote UE or transmitting UE) and transmit a reservation signal 806 (e.g., request) indicating the SL-RS scheduled resources 808 to the scheduled UE. In some examples, the request 806 may be received by another scheduling UE in the sidelink network and utilized by the other scheduling UE to schedule additional SL-RS resources 810 for other scheduled UEs (e.g., UE2 and UE3). Using the example again shown in FIG. 4, the scheduling UE may correspond to the relay UE 402b and the scheduled UE (UE1) may correspond to the remote UE 402e. The request 806 transmitted by the relay UE 402b may be received by the relay UE 402a. The relay UE 402a may then schedule SL-RS resources 810 for remote UEs 402c and 402d (UE2 and UE3) based on the SL-RS request 806. For example, the relay UE 402a may rate-match the SL-RS resources 810 for remote UEs 402c and 402d around the SL-RS resources 808 scheduled for remote UE 402e. This approach can lead to improved resource efficiency in scheduling SL-RS resources 808 and 810. A similar resource allocation configuration may further be utilized for reports (e.g., CSI reports) generated based on SL-RSs.

There may be examples in which a UE (e.g., UE1) is allocated SL-RS resources (or report resources) by two different scheduling UEs. For example, UE1 may receive a first request from a first scheduling UE and a second request from a second scheduling UE for the purpose of channel estimation. The scheduled resources indicated in the first request and the second request may overlap in time, either fully or partially. Hence, UE1 may not be able to accommodate both requests. For example, UE 1 may not be capable of simultaneous transmissions (e.g., when the transmissions are on the same carrier). There may also be examples in which a UE (e.g., UE1) has sent a first request to another scheduled UE requesting the other scheduled UE to transmit a SL-RS (or report) to the UE1, while also receiving a second request from a scheduling UE to transmit a SL-RS (or report) to the scheduling UE. The resources indicated in the first and second requests may overlap in time, either fully or partially. As a result, the transmission and reception of the two SL-RSs or the two reports may collide.

Therefore, various aspects of the disclosure relate to prioritizing SL-RSs when the resources scheduled for two or more SL-RSs or two or more reports generated based on the corresponding SL-RSs at least partially overlap in the time domain. In some examples, the SL-RSs may be prioritized based on at least one prioritization rule associated with the SL-RSs. The prioritization rule(s) enable a UE to select one of the SL-RSs for communication of a corresponding sidelink communication (e.g., SL-RS or corresponding report) within the overlapping resources. For example, the prioritization rule(s) may provide a prioritization between SL-RSs based on one or more of: the timing behavior (e.g., periodic, semi-persistent, or aperiodic) of the SL-RSs and/or reports; the time each of the requests was sent and/or received; the cast type (e.g., unicast, broadcast, or groupcast) of the sidelinks associated with the requests; the type of SL-RS (e.g., SL CSI-RS, SL PRS, SL SRS, SL DM-RS, etc.); the report type (e.g., type of CSI information included in a CSI report or frequencies over which the CSI information is obtained) of a report generated based on the SL-RSs; the number of resources assigned to the requests, the SL-RSs, or the reports generated from the SL-RSs; the time each of the reports should be transmitted; the source identifier (ID) of the requests; the priority indicated in each of the requests; the priority associated with sidelinks on which the sidelink communications are communicated; the resource pool ID of the scheduled resources, the carrier ID of the scheduled resources; the zone ID associated with the requests; the sidelink resource allocation mode (e.g., Mode 1 or Mode 2) utilized for the SL-RSs or reports generated from the SL-RSs; and/or the communication direction (e.g., transmission or reception) of the SL-RSs and/or reports.

In some examples, the UE may communicate (e.g., transmit or receive) the selected SL-RS within the overlapping resources and may communicate the selected SL-RS and/or another SL-RS (e.g., a non-selected SL-RS) within non-overlapping resources. In some examples, the UE performing prioritization may inform the other devices (e.g., other UE(s) and/or a base station) associated with non-selected sidelink communications (e.g., non-selected SL-RSs and/or corresponding reports) that the non-selected sidelink communications were dropped. For example, the prioritizing UE may transmit a feedback indication to the other devices associated with non-selected sidelink communications including a negative acknowledgment (NACK) of the associated request. The feedback indication may be transmitted, for example, within a PSFCH or PUCCH. In some examples, the prioritizing UE may further transmit a feedback indication to the device associated with the selected sidelink communication (e.g., selected SL-RS and/or report), including an ACK of the associated request.

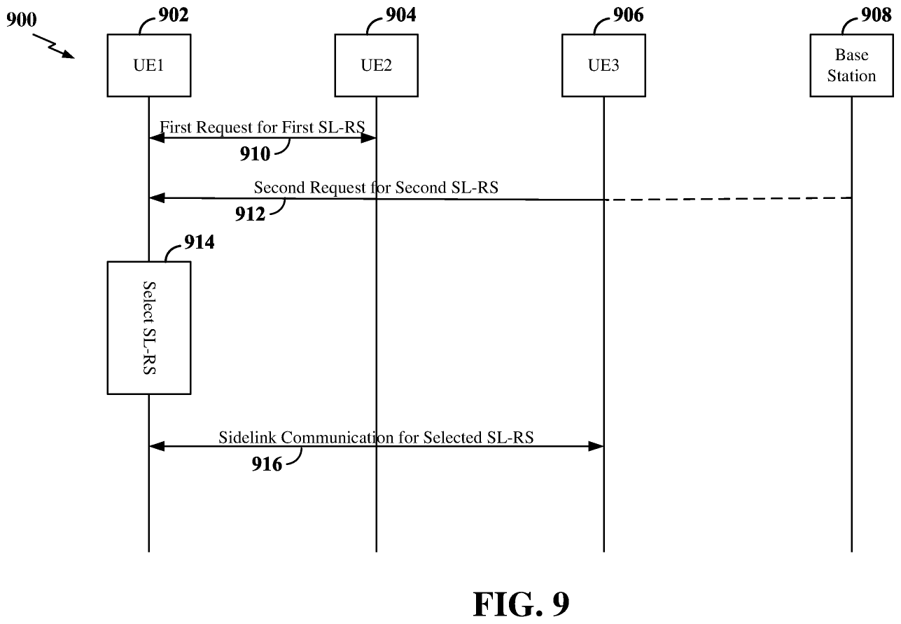

FIG. 9 is a signaling diagram illustrating exemplary signaling 900 for SL-RS prioritization between UEs 902, 904, and 906 and a base station 908 according to some aspects. The base station 908 may be any of the base stations (e.g., gNB, eNB, etc.) or scheduling entities shown in FIGS. 1, 3, 4, and/or 6A-6C. The UEs 902, 904, and 906 may be any of the UEs or scheduled entities shown in FIGS. 1, 3, 4, and/or 6A-6C.

At 910, a first UE (UE1) 902 may transmit or receive a first request to or from a second UE (UE2) 904. The first request may be communicated over first sidelink resources (e.g., a number of sidelink symbols, a number of RBs, and a number of repetitions) allocated to the first request. The first request may be associated with a first SL-RS and include, for example, a request for communication (e.g., transmission or reception) of a first sidelink communication (e.g., the first SL-RS or a corresponding first report generated based on the first SL-RS) within a first set of resources (e.g., a number of sidelink symbols, a number of RBs, and a number of repetitions). In some examples, the resources may be configured via an RRC message, and the request may be included within SCI or a sidelink MAC-CE triggering the first set of resources. The first request may further indicate a resource pool ID and/or carrier ID associated with the first set of resources.

In some examples, the first request may further include a timing behavior (e.g., periodic, semi-persistent, or aperiodic) of the first SL-RS and/or first report, a cast type (e.g., unicast, broadcast, or groupcast) of the first SL-RS and/or report, and a reference signal type of the first SL-RS (e.g., SL CSI-RS, SL PRS, SL SRS, SL DM-RS, etc.). In addition, the first SL-RS request may further include a source ID of the UE (e.g., UE1 or UE2) transmitting the first request and/or a zone ID of at least the transmitting UE (e.g., the UE transmitting the first SL-RS and/or first report). In some examples, the first request may further include a priority assigned to the first SL-RS and/or first report.

In some examples, the first request may include report information related to the first report to be generated based on the first SL-RS request. The report information may include, for example, a report type (e.g., type of CSI information included in a CSI report or frequencies over which the CSI information is obtained) and an allocation of report resources (e.g., time-frequency resources) over which the report may be transmitted. The report information may further indicate a priority assigned to the channel carrying the report. In some examples, the sidelink resources allocated for transmission of the first SL-RS and/or first report may be indicated by the base station 908 for Mode 1 sidelink resource allocation or by a scheduling UE (e.g., UE1 or UE2) for Mode 2 sidelink resource allocation.

At 912, UE1 902 may further receive a second request from a third UE (UE3) 906 or from the base station 908 via, for example, UE3 906. The second SL-RS request may be communicated over second sidelink resources (e.g., a number of sidelink symbols, a number of RBs, and a number of repetitions) or over Uu resources allocated to the second request. In examples in which the UE3 906 is a relay UE (as shown in FIG. 9), the second request may be received by the UE3 906 in DCI and/or a MAC-CE, and then forwarded to the UE1 902 in SCI and/or a sidelink MAC-CE. The second request may be associated with a second SL-RS and include, for example, a request for transmission of a second sidelink communication (e.g., the second SL-RS and/or a corresponding second report generated based on the second SL-RS) from the UE1 902 to the UE3 906 within a second set of resources (e.g., a number of sidelink symbols, a number of RBs, and a number of repetitions). The second request may further include additional information, as described above.

At 914, UE1 902 may determine that the first set of resources and the second set of resources at least partially overlap in the time domain (e.g., the first set of resources includes at least one same symbol as the second set of resources). In some examples, the first set of resources and the second set of resources may further be in the same resource pool or different resource pools, the same or different component carriers, or the same or different frequency bands. The UE1 902 may then select the first SL-RS or the second SL-RS as a selected SL-RS for communication of a corresponding selected sidelink communication (e.g., the selected SL-RS or corresponding report generated based on the selected SL-RS) within at least the overlapping resources between the first set of resources and the second set of resources. In some examples, the UE1 902 may select the selected SL-RS based on at least one prioritization rule associated with the first SL-RS and the second SL-RS. The prioritization rule(s) may be applied in case of a collision between transmissions of the first and second sidelink communications, a collision between receptions of the first and second sidelink communications, or a collision between a reception of the first sidelink communication and a transmission of the second sidelink communication.

For example, a prioritization rule may include a prioritization between a respective timing behavior (e.g., periodic, semi-persistent, or aperiodic) of the first SL-RS and the second SL-RS and/or the first report and the second report. For example, an aperiodic SL-RS/report may be prioritized over a periodic SL-RS/report. Thus, if the first SL-RS/first report is aperiodic and the second SL-RS/second report is periodic, the UE1 902 may select the first SL-RS as the selected SL-RS. Another prioritization rule may provide a prioritization between a respective time of communication of each of the first request and the second request. The time of communication may correspond to the time the request was sent and/or received. For example, an earlier received request may be prioritized over a later received request. Another prioritization rule may provide a prioritization between a respective time of transmission of the respective reports associated with each of the first request and the second request. For example, an earlier transmitted report may be prioritized over a later transmitted report.

Another prioritization rule may provide a prioritization between a respective cast type (e.g., unicast, broadcast, or groupcast) of a respective sidelink associated with each of the first request and the second request. Here, the cast type may indicate whether the UE1 902 has a unicast sidelink, broadcast sidelink, or groupcast sidelink with the other UE (e.g., UE2 or UE3). For example, a request (e.g., the first request) received from (or transmitted to) a UE (e.g., UE2 904) with which UE1 902 has a unicast connection may be prioritized over a request (e.g., the second request) received from (or transmitted to) a UE (e.g., UE3 904) with which UE1 902 has a groupcast or broadcast connection. As another example, a SL-RS or report (e.g., the first SL-RS or first report) received from (or transmitted to) a UE (e.g., UE2 904) with which the UE1 902 has a groupcast connection may be prioritized over a SL-RS or report (e.g., the second SL-RS or report) received from (or transmitted to) a UE (e.g., UE3 904) with which UE1 902 has a broadcast connection.

Another prioritization rule may provide for a prioritization between a respective reference signal type of each of the first SL-RS and the second SL-RS. For example, a SL PRS may be prioritized over a SL CSI-RS. Another prioritization rule may provide a prioritization between a respective report type associated with each of the first report and the second report. For example, the report type may indicate the content(s) included in each report (e.g., CSI report) generated based on the first and second SL-RSs. As an example, a CSI report containing CQI, RI, and PMI may be prioritized over a CSI report containing only CQI and RI. As another example, the report type may indicate the frequencies over which the report is generated. For example, a wide-band report may be prioritized over a sub-band report, or vice versa.

Another prioritization rule may provide for a prioritization between a respective number of resources (e.g., number of sidelink symbols, number of RBs, and/or number of repetitions) over which each of the first request and the second request are communicated. Another prioritization rule may provide for a prioritization between a respective number of resources (e.g., number of sidelink symbols, number of RBs, and/or number of repetitions) allocated for each of the first sidelink communication (e.g., first SL-RS or the first report) and the second sidelink communication (e.g., the second SL-RS or the second report).

Another prioritization rule may provide for a prioritization between the respective source IDs of the first and second requests. For example, a request transmitted to or received from a relay UE may be prioritized over a request transmitted to or received from another UE with which UE1 902 has a sidelink connection. As another example, a request transmitted to or received from a base station 908 may be prioritized over a request transmitted to or received from another UE.

Another prioritization rule may include a prioritization between the first and second SL-RSs based on the respective priority assigned to each of the first and second sidelink communications (e.g., the SL-RSs and/or reports) in the first and second requests. For example, a higher priority sidelink communication may be prioritized over a lower priority sidelink communication. Another prioritization rule may include a prioritization between the first and second SL-RSs based on a respective priority of the corresponding sidelinks on which the first and second SL-RSs/reports may be communicated. For example, the sidelink priorities may be determined based on the priority of packets communicated on each of the sidelinks or the respective priorities assigned to the channels carrying the reports. In this example, a SL-RS to be communicated on a sidelink having higher priority packets or a higher priority channel on which the report is sent may be prioritized over a SL-RS to be communicated on a sidelink having lower priority packets or a lower priority channel on which the report is sent.

Another prioritization rule may include a prioritization between respective resource pool IDs associated with the first set of resources and the second set of resources. For example, a sidelink communication to be communicated on a set of resources in a first resource pool may be prioritized over a sidelink communication to be communicated on a set of resources in a second resource pool. Another prioritization rule may include a prioritization between respective carrier IDs associated with the first set of resources and the second set of resources. For example, a sidelink communication to be communicated on a first carrier may be prioritized over a sidelink communication to be communicated on a second carrier. Another prioritization rule may include a prioritization between sidelink resource allocation modes (e.g., Mode 1 and Mode 2) of the SL-RS transmission/reception and/or report transmission/reception. For example, a SL-RS (or associated report) scheduled based on Mode 1 may be prioritized over a SL-RS (or associated report) scheduled based on Mode 2.

Another prioritization rule may include a prioritization between the respective zone IDs associated with the first and second requests. The zone ID represents a geographical area, and as such, can be used to determine a first distance between UE1 902 and UE2 904 and a second distance between UE1 and UE3. In this example, the SL-RS associated with the sidelink communication having with the lowest distance (or highest distance) between the first and second distances may be selected.

Another prioritization rule may include a prioritization between the respective communication directions (e.g., transmission or reception) of the sidelink communications. For example, a sidelink communication (e.g., SL-RS or report) being received by UE1 902 may be prioritized over a sidelink communication (e.g., SL-RS or report) being transmitted by UE1 902. Other prioritization rules may further be designed, and the present disclosure is not limited to any particular prioritization rules.

In some examples, the prioritization rules may be ranked. For example, UE1 may prioritize based on the timing behavior first, and then if both SL-RSs (or both reports) have the same timing behavior, UE1 may prioritize based on when the first and second requests were communicated. In some examples, groups of prioritization rules may be defined, where each group includes one or more of the prioritization rules. The prioritization rules may further be ranked within the groups. For example, a first group of prioritization rules may include the source ID prioritization rule and transmission direction prioritization rule. The transmission direction prioritization rule may be ranked first and the source ID rule may be ranked second. In addition, a second group of prioritization rules may include the SL-RS type prioritization rule, the number of resources prioritization rule, and the resource pool ID prioritization rule. The SL-RS type prioritization rule may be ranked first, the number of resources prioritization rule may be ranked second, and the resource pool ID prioritization rule may be ranked third. In this example, the UE1 may select one of the prioritization rule groups and then apply the prioritization rules in the selected group in order based on their ranking until a SL-RS is selected.

Once the UE1 902 has selected the selected SL-RS based on the prioritization rule(s), at 916, the UE1 902 may communicate (e.g., transmit or receive) the corresponding selected sidelink communication (e.g., selected SL-RS or corresponding report) within at least the overlapping resources between the first set of resources and the second set of resources. In the example shown in FIG. 9, the UE1 902 selected the second SL-RS associated with the second request for communication of the corresponding second sidelink communication with UE3 906.

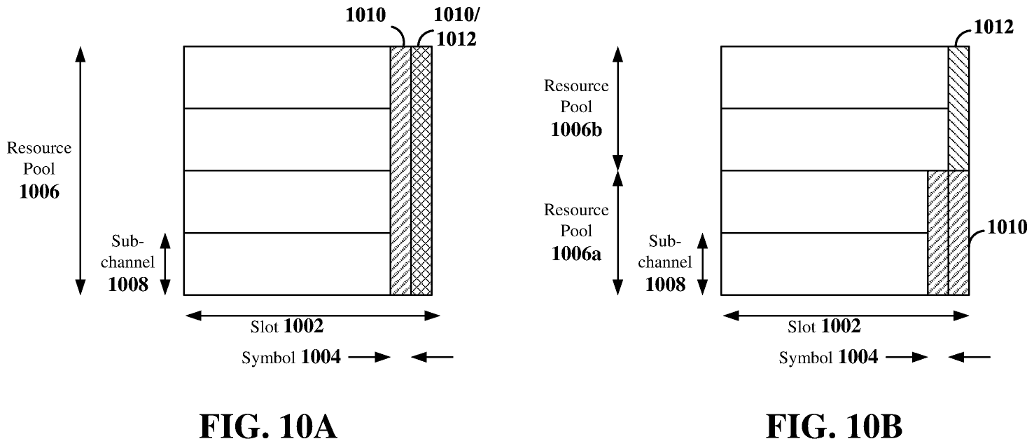

FIGS. 10A and 10B are diagrams illustrating exemplary overlapping SL-RS scheduled resources according to some aspects. In the example shown in FIG. 10, time is in the horizontal direction with units of slots 1002 and symbols 1004 (e.g., OFDM symbols); and frequency is in the vertical direction with units of sub-channels 1008 of one or more resource pools 1006. Each sub-channel may include a configurable number of PRBs (e.g., 10, 15, 20, 25, 50, 55, or 100 PRBs).

A first SL-RS 1010 is shown scheduled in two symbols (e.g., the last two symbols) 1004 of the slot 1002, whereas a second SL-RS 1012 is shown scheduled in a single symbol (e.g., the last symbol) 1004 of the slot 1002. Thus, each of the first SL-RS 1010 and second SL-RS 1012 are scheduled to be communicated on the same symbol (e.g., the last symbol) 1004 of the slot 1002, and as such, they are partially overlapping in the time domain.

In the example shown in FIG. 10A, a single resource pool 1006 including a plurality of sub-channels 1008 is illustrated. The first SL-RS 1010 and the second SL-RS 1012 are each wide-band SL-RSs spanning all sub-channels (RBs) 1008 in the resource pool 1006. In the example shown in FIG. 10B, two resource pools 1006a and 1006b are illustrated. The first SL-RS 1010 is scheduled in a first resource pool 1006a and the second SL-RS 1012 is scheduled in a second resource pool 1006b.

In each of the examples shown in FIGS. 10A and 10B, a UE scheduled to transmit or receive each of the first and second SL-RSs 1010 and 1012 may prioritize one of the SL-RSs to be communicated in at least the overlapping resources (e.g., at least within the last symbol 1004 of the slot 1002). For example, the UE may prioritize one of the first SL-RS 1010 or the second SL-RS 1012 to be communicated in the last symbol 1004 of the slot 1002 using one or more of the prioritization rules discussed above in connection with FIG. 9. As an example, the UE may prioritize the first SL-RS for communication in the last symbol 1004 based on the larger number of resources (larger number of symbols) allocated for the first SL-RS. In examples in which the UE selects the first SL-RS 1010 for communication in the last symbol 1004 of the slot 1002, the UE may further communicate the first SL-RS 1010 on the non-overlapping resources (e.g., the second to last symbol 1004) in the slot 1002.

In the example shown in FIG. 10B, the UE may prioritize the second SL-RS 1012 for communication in the last symbol 1004 based on the resource pool ID of the resource pool 1006b within which the second SL-RS 1012 is scheduled. In examples in which the UE selects the second SL-RS 1012 for communication in the last symbol 1004 of the slot 1002, the UE may either communicate the first SL-RS 1010 on the non-overlapping resources (e.g., the second to last symbol 1004 of the slot 1002) or avoid communication of (e.g., not transmit or receive) the first SL-RS 1010 on the non-overlapping resources in the slot 1002. Thus, in the case of a partial collision, the UE may apply the prioritization rule to only the portion of the first SL-RS that is overlapping or to the entire first SL-RS (e.g., prioritize the second SL-RS request associated with the second SL-RS over the entire first SL-RS request associated with the first SL-RS).

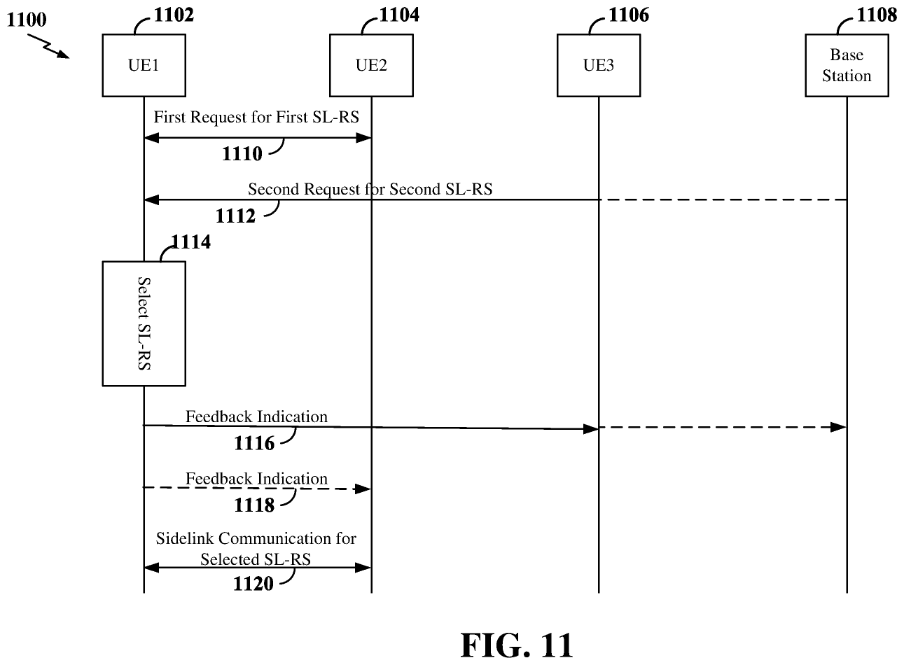

FIG. 11 is a signaling diagram illustrating exemplary signaling for SL-RS prioritization and reporting of the prioritization between UEs 1102, 1104, and 1104 and a base station 1108 according to some aspects. The base station 1108 may be any of the base stations (e.g., gNB, eNB, etc.) or scheduling entities shown in FIGS. 1, 3, 4, 6A-6C, and/or 9. The UEs 1102, 1104, and 1106 may be any of the UEs or scheduled entities shown in FIGS. 1, 3, 4, 6A-6C, and/or 9.

At 1110, a first UE (UE1) 1102 may transmit or receive a first request to or from a second UE (UE2) 1104. The first request may be communicated over first sidelink resources (e.g., a number of sidelink symbols, a number of RBs, and a number of repetitions) allocated to the first request. The first request may be associated with a first SL-RS and may include, for example, a request for communication (e.g., transmission or reception) of a first sidelink communication (e.g., the first SL-RS or a corresponding first report generated based on the first SL-RS) within a first set of resources (e.g., a number of sidelink symbols, a number of RBs, and a number of repetitions). In some examples, the resources may be configured via an RRC message, and the request may be included within SCI or a sidelink MAC-CE triggering the first set of resources. The first request may further indicate a resource pool ID and/or carrier ID associated with the first set of resources.

In some examples, the first request may further include a timing behavior (e.g., periodic, semi-persistent, or aperiodic) of the first SL-RS and/or first report, a cast type (e.g., unicast, broadcast, or groupcast) of the first SL-RS and/or first report, and a reference signal type of the first SL-RS (e.g., SL CSI-RS, SL PRS, SL SRS, SL DM-RS, etc.). In addition, the first request may further include a source ID of the UE (e.g., UE1 or UE2) transmitting the first request and/or a zone ID of at least the transmitting UE (e.g., the UE transmitting the first SL-RS or first report). In some examples, the first request may further include a priority assigned to the first SL-RS and/or first report.

In some examples, the first request may include report information for the first report to be generated based on the first SL-RS. The report information may include, for example, a report type (e.g., type of CSI information included in a CSI report or frequencies over which the CSI information is obtained) and an allocation of report resources (e.g., time-frequency resources) over which the report may be transmitted. The report information may further indicate a priority assigned to the channel carrying the report. In some examples, the sidelink resources allocated for transmission of the SL-RS and/or report may be indicated by the base station 1108 for Mode 1 sidelink resource allocation or by a scheduling UE (e.g., UE1 or UE2) for Mode 2 sidelink resource allocation.

At 1112, UE1 1102 may further receive a second request from a third UE (UE3) 1106 or from the base station 1108 via, for example, UE3 1106. The second request may be communicated over second sidelink resources (e.g., a number of sidelink symbols, a number of RBs, and a number of repetitions) or over Uu resources allocated to the second request. In examples in which the UE3 1106 is a relay UE (as shown in FIG. 11), the second request may be received by the UE3 1106 in DCI and/or MAC-CE and then forwarded to the UE1 1102 in a SCI and/or sidelink MAC-CE. The second request may be associated with a second SL-RS include, for example, a request for transmission of a second sidelink communication (e.g., the second SL-RS or a corresponding second report generated based on the second SL-RS) from the UE1 1102 to the UE3 1106 within a second set of resources (e.g., a number of sidelink symbols, a number of RBs, and a number of repetitions). The second request may further include additional information, as described above.

At 1114, UE1 1102 may determine that the first set of resources and the second set of resources at least partially overlap in the time domain (e.g., the first set of resources includes at least one same symbol as the second set of resources). The UE1 1102 may then select the first SL-RS or the second SL-RS as a selected SL-RS as a selected SL-RS for communication of a corresponding selected sidelink communication (e.g., the selected SL-RS or corresponding report generated based on the selected SL-RS) within at least the overlapping resources between the first set of resources and the second set of resources. In some examples, the UE1 1102 may select the selected SL-RS based on at least one prioritization rule associated with the first SL-RS and the second SL-RS. The prioritization rule(s) may be applied in case of a collision between transmissions of the first and second sidelink communications, a collision between receptions of the first and second sidelink communications, or a collision between a reception of the first sidelink communication and a transmission of the second sidelink communication. The prioritization rules may include one or more of the prioritization rules discussed above in connection with FIG. 9. The prioritization rules may further be ranked and/or grouped, as further discussed above.

Once the UE1 1102 has selected the selected SL-RS based on the prioritization rule(s), at 1116, the UE1 1102 may inform the device (e.g., other UE or base station) associated with the non-selected SL-RS that the request associated with the non-selected SL-RS was dropped. Notifying the device associated with the non-selected SL-RS may improve channel estimation or positioning quality, depending on whether the SL-RS is a SL CSI-RS or a SL PRS.

In the example shown in FIG. 11, the UE1 1102 selected the first SL-RS associated with the first request for communication of the first sidelink communication (e.g., first SL-RS or first report) with UE2 1104. Thus, at 1116, UE1 1102 can transmit a feedback indication to the device (e.g., UE3 1106 or base station 1108) that scheduled the second sidelink communication (e.g., the device that generated the second request). The feedback indication may indicate, for example, that the second request was dropped (e.g., the SL-RS and/or report transmission associated with the second request will not occur). In some examples, the feedback indication may include a negative acknowledgement (NACK). For example, the UE1 1102 may transmit the feedback indication including the NACK on a PSFCH to UE3 1106 or a PUCCH to the base station 1108. In examples in which UE3 1106 is a relay UE, UE3 1106 may forward the feedback indication to the base station 1108 in a PUCCH.

In examples in which the feedback indication is transmitted on a PUCCH, the feedback indication may be transmitted on a set of feedback resources indicated in, for example, DCI that included the second request. In examples in which the feedback indication is transmitted on a PSFCH, the feedback indication may be transmitted on a set of sidelink feedback resources based on a mapping between the set of sidelink feedback resources and the second set of resources associated with the non-selected sidelink communication (e.g., the second SL-RS or second report). In other examples, the feedback indication may be transmitted on a set of sidelink feedback resources based on a mapping between the set of sidelink feedback resources and the second request associated with the non-selected sidelink communication (e.g., the second SL-RS or second report). The mapping may be predefined or indicated, for example, in the second request.

At 1118, the UE1 1102 may further optionally transmit a feedback indication to the device (e.g., UE2 1104) that scheduled the selected sidelink communication (e.g., the first SL-RS or first report). The feedback indication may include, for example, an acknowledgement (ACK). For example, the UE1 1102 may transmit the feedback indication including the ACK on a PSFCH to UE2 1104. In examples in which the selected sidelink communication was scheduled by the base station 1108, the UE1 1102 may transmit the feedback indication including the ACK on a PUCCH to the base station 1108. Feedback resources for transmitting the feedback indication may be defined, as described above. At 1120, the UE1 1102 may communicate (e.g., transmit or receive) the selected sidelink communication (e.g., the first SL-RS or first report) within at least the overlapping resources between the first set of resources and the second set of resources.

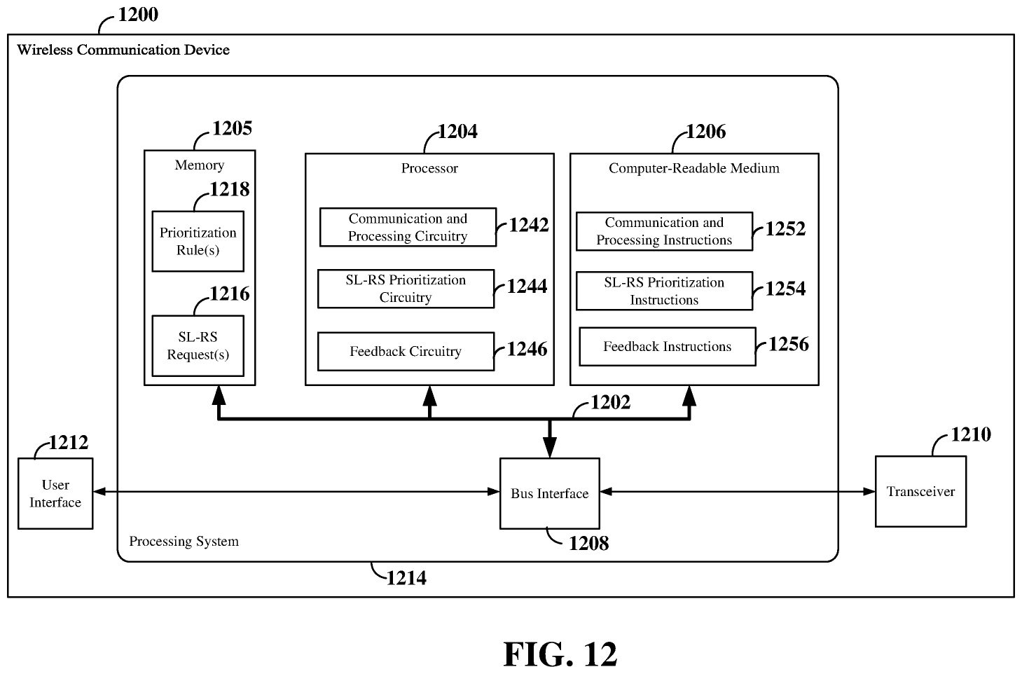

FIG. 12 is a block diagram illustrating an example of a hardware implementation for a wireless communication device 1200 employing a processing system 1214. For example, the wireless communication device 1200 may correspond to a sidelink device, such as a V2X device, D2D device or other UE or wireless communication device configured for sidelink communication, as shown and described above in reference to FIGS. 1, 3, 4, 6A-6C, 9, and/or 11.

The wireless communication device 1200 may be implemented with a processing system 1214 that includes one or more processors 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1200 may be configured to perform any one or more of the functions described herein. That is, the processor 1204, as utilized in the wireless communication device 1200, may be used to implement any one or more of the processes and procedures described below.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors (represented generally by the processor 1204), a memory 1205, and computer-readable media (represented generally by the computer-readable medium 1206). The bus 1202 may also link various other circuits such as timing sources, peripherals, voltage regulators, and power management circuits, which are well known in the art, and therefore, will not be described any further.

A bus interface 1208 provides an interface between the bus 1202 and a transceiver 1210. The transceiver 1210 provides a means for communicating with various other apparatus over a transmission medium (e.g., air interface). Depending upon the nature of the apparatus, a user interface 1212 (e.g., keypad, display, touch screen, speaker, microphone, control knobs, etc.) may also be provided. Of course, such a user interface 1212 is optional, and may be omitted in some examples.

The processor 1204 is responsible for managing the bus 1202 and general processing, including the execution of software stored on the computer-readable medium 1206. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1204, causes the processing system 1214 to perform the various functions described below for any particular apparatus. The computer-readable medium 1206 and the memory 1205 may also be used for storing data that is manipulated by the processor 1204 when executing software.

The computer-readable medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1206 may reside in the processing system 1214, external to the processing system 1214, or distributed across multiple entities including the processing system 1214. The computer-readable medium 1206 may be embodied in a computer program product. By way of example, a computer program product may include a computer-readable medium in packaging materials. In some examples, the computer-readable medium 1206 may be part of the memory 1205. Those skilled in the art will recognize how best to implement the described functionality presented throughout this disclosure depending on the particular application and the overall design constraints imposed on the overall system.

In some aspects of the disclosure, the processor 1204 may include circuitry configured for various functions. For example, the processor 1204 may include communication and processing circuitry 1242, configured to communicate with one or more sidelink devices (e.g., other UEs) via a sidelink (e.g., PC5 interface). In addition, the communication and processing circuitry 1242 may be configured to communicate with a base station (e.g., gNB or eNB) via a Uu link. In some examples, the communication and processing circuitry 1242 may include one or more hardware components that provide the physical structure that performs processes related to wireless communication (e.g., signal reception and/or signal transmission) and signal processing (e.g., processing a received signal and/or processing a signal for transmission).

In some implementations where the communication involves receiving information, the communication and processing circuitry 1242 may obtain information from a component of the wireless communication device 1200 (e.g., from the transceiver 1210 that receives the information via radio frequency signaling or some other type of signaling suitable for the applicable communication medium), process (e.g., decode) the information, and output the processed information. For example, the communication and processing circuitry 1242 may output the information to another component of the processor 1204, to the memory 1205, or to the bus interface 1208. In some examples, the communication and processing circuitry 1242 may receive one or more of signals, messages, other information, or any combination thereof. In some examples, the communication and processing circuitry 1242 may receive information via one or more channels. In some examples, the communication and processing circuitry 1242 may include functionality for a means for receiving. In some examples, the communication and processing circuitry 1242 may include functionality for a means for processing, including a means for demodulating, a means for decoding, etc.

In some implementations where the communication involves sending (e.g., transmitting) information, the communication and processing circuitry 1242 may obtain information (e.g., from another component of the processor 1204, the memory 1205, or the bus interface 1208), process (e.g., modulate, encode, etc.) the information, and output the processed information. For example, the communication and processing circuitry 1242 may output the information to the transceiver 1210 (e.g., that transmits the information via radio frequency signaling or some other type of signaling suitable for the applicable communication medium). In some examples, the communication and processing circuitry 1242 may send one or more of signals, messages, other information, or any combination thereof. In some examples, the communication and processing circuitry 1242 may send information via one or more channels. In some examples, the communication and processing circuitry 1242 may include functionality for a means for sending (e.g., a means for transmitting). In some examples, the communication and processing circuitry 1242 may include functionality for a means for generating, including a means for modulating, a means for encoding, etc.

In some examples, the communication and processing circuitry 1242 may be configured to receive a request for communication of a sidelink communication corresponding to a SL-RS or a report (e.g., CSI report) generated based on the SL-RS within a set of resources via the transceiver 1210. The request may be received from another wireless communication device (e.g., a UE/sidelink device) or a base station (e.g., gNB or eNB). In some examples, the request from the base station may be forwarded to the wireless communication device 1200 via a relay sidelink device. In some examples, the request may be included within DCI, SCI, and/or a MAC-CE. For example, the set of resources for communication of the sidelink communication may be configured via RRC messaging and then activated or triggered via DCI, SCI, and/or a MAC-CE.

The communication and processing circuitry 1242 may further be configured to transmit a request for communication of a sidelink communication corresponding to a SL-RS or a report (e.g., CSI report) within a set of resources via the transceiver 1210. In this example, the request may be transmitted to another wireless communication device (e.g., a UE/sidelink device). In some examples, the request may be included within SCI and/or a sidelink MAC-CE. The communication and processing circuitry 1242 may further be configured to transmit a sidelink communication (e.g., SL-RS or report) and/or receive a sidelink communication (e.g., SL-RS or report) on a corresponding set of resources via the transceiver 1210.

The communication and processing circuitry 1242 may further be configured to transmit a feedback indication to a device (e.g., a UE or base station) associated with a sidelink communication (e.g., SL-RS or report) indicating whether the sidelink communication is to be transmitted to or received from the device. The communication and processing circuitry 1242 may further be configured to execute communication and processing instructions (software) 1252 stored in the computer-readable medium 1206 to implement one or more of the functions described herein.

The processor 1204 may further include SL-RS prioritization circuitry 1244, configured to determine whether a collision between transmissions or receptions of two or more sidelink communications (e.g., SL-RSs or reports generated based on SL-RSs) may occur. For example, the communication and processing circuitry 1242 may receive requests for transmissions of respective sidelink communications (e.g., SL-RSs or reports generated therefrom) from two different devices (e.g., two UEs or a UE and a base station). If the resources allocated for the two sidelink transmissions overlap in time, either fully or partially, the sidelink transmissions will collide in the time domain. Hence, the wireless communication device 1200 may not be able to accommodate both requests. As another example, the communication and processing circuitry 1242 may transmit a request for a reception of a sidelink communication (e.g., SL-RS or report generated therefrom) from a first device (e.g., a UE) and may further receive a request for a transmission of a sidelink communication (e.g., SL-RS or report generated therefrom) from a second device (e.g., a UE or a base station). If the resources allocated for the sidelink transmission and sidelink reception overlap in time, either fully or partially, the transmission and reception of the two sidelink communications will collide.

When a first set of resources allocated for communication of a first sidelink communication corresponding to a first SL-RS or first report at least partially overlap in the time domain with a second set of resources allocated for communication of a second sidelink communication corresponding to a second SL-RS or second report, the SL-RS prioritization circuitry 1244 may be configured to select one of the first SL-RS or the second SL-RS as a selected SL-RS for communication of a corresponding sidelink communication (e.g., the selected SL-RS or corresponding report associated with the selected SL-RS) within at least overlapping resources between the first and second sets of resources. In some examples, the SL-RS prioritization circuitry 1244 may be configured to select the selected SL-RS based on at least one prioritization rule associated with the first and second SL-RSs. Examples of prioritization rules are discussed above in connection with FIG. 9.

In some examples, the SL-RS prioritization circuitry 1244 may further be configured to select the selected SL-RS for communication within the overlapping resources and to further select the other (non-selected) SL-RS for communication within non-overlapping resources between the first and second sets of resources. In addition, in examples in which the set of resources allocated for the selected SL-RS includes non-overlapping resources, the SL-RS prioritization circuitry 1244 may further be configured to select the selected SL-RS for communication in both the overlapping and the non-overlapping resources. The SL-RS prioritization circuitry 1244 may further be configured to execute SL-RS prioritization instructions (software) 1254 stored in the computer-readable medium 1206 to implement one or more of the functions described herein.

The processor 1204 may further include feedback circuitry 1246, configured to generate and transmit, via the communication and processing circuitry 1242 and transceiver 1210, a feedback indication to at least the device associated with the non-selected SL-RS. For example, the feedback indication may indicate that the request associated with the non-selected SL-RS was dropped. For example, the feedback indication may indicate that the sidelink communication (e.g., SL-RS and/or report) will not be communicated. In some examples, the feedback indication may include a NACK. The NACK may be transmitted within a PSFCH to a UE or a PUCCH to a base station. In examples in which the NACK is transmitted within the PSFCH, the feedback circuitry 1246 may further be configured to identify a set of feedback resources based on a mapping between the set of feedback resources and either the set of resources allocated for communication of the non-selected sidelink communication or the request associated with the non-selected SL-RS.

In some examples, the feedback circuitry 1246 may further be configured to transmit a feedback indication to the device associated with the selected SL-RS. In this example, the feedback indication may include an ACK. The feedback circuitry 1246 may further be configured to execute feedback instructions (software) 1256 stored in the computer-readable medium 1206 to implement one or more of the functions described herein.

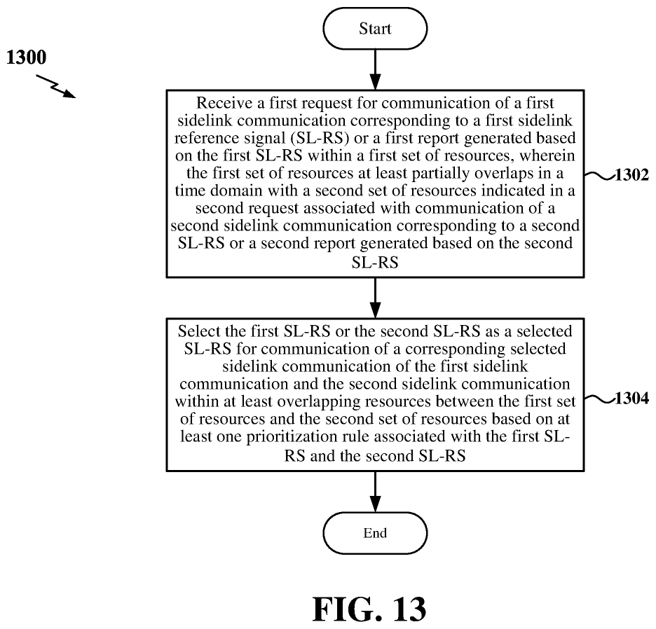

FIG. 13 is a flow chart 1300 of an exemplary method for SL-RS prioritization according to some aspects. As described below, some or all illustrated features may be omitted in a particular implementation within the scope of the present disclosure, and some illustrated features may not be required for implementation of all embodiments. In some examples, the method may be performed by the wireless communication device 1200, as described above and illustrated in FIG. 12, by a processor or processing system, or by any suitable means for carrying out the described functions.

At block 1302, the wireless communication device (e.g., a UE configured for sidelink communication) may receive a first request for communication of a first sidelink communication corresponding to a first reference signal (SL-RS) or a first report generated based on the first SL-RS within a first set of resources. The first set of resources may at least partially overlap in a time domain with a second set of resources indicated in a second request for communication of a second sidelink communication corresponding to a second SL-RS or a second report generated based on the second SL-RS. For example, the first request may be received from a first device (e.g., another UE or a base station (e.g., via a relay UE)) and the second request may either be received from a second device (e.g., UE or base station) or transmitted to the second device from the wireless communication device. For example, the communication and processing circuitry 1242 and transceiver 1210, shown and described above in connection with FIG. 12, may provide a means to receive the first request.

At block 1304, the wireless communication device may select the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS. In some examples, the at least one prioritization rule includes a prioritization between a respective timing behavior of the first sidelink communication and the second sidelink communication. For example, the timing behavior may include periodic, semi-persistent, or aperiodic. In other examples, the at least one prioritization rule includes a prioritization between a respective time of communication of each of the first request and the second request.

In other examples, the at least one prioritization rule includes a prioritization between a respective cast type of a respective sidelink associated with the first request and the second request. The cast type can include, for example, unicast, broadcast, or groupcast. In other examples, the at least one prioritization rule includes a prioritization between a respective reference signal type of the first SL-RS and the second SL-RS. In other examples, the at least one prioritization rule includes a prioritization between a first report type of the first report to be generated based on the first SL-RS and a second report type of the second report to be generated based on the second SL-RS or a first transmission time of the first report and a second transmission time of the second report.

In other examples, the at least one prioritization rule includes a prioritization between a respective first number of resources associated with the first request and the second request or a respective second number of resources associated with the first set of resources and the second set of resources. In other examples, the at least one prioritization rule comprises a prioritization between a respective source identity (ID) associated with the first request and the second request. In some examples, the at least one prioritization rule comprises a prioritization between a respective sidelink resource allocation mode associated with the first request and the second request.

In other examples, the at least one prioritization rule includes a prioritization between a respective first priority of each of the first sidelink communication and the second sidelink communication or a respective second priority associated with a first sidelink on which the first sidelink communication is communicated and a second sidelink on which the second sidelink communication is communicated. In this example, the first request can include a first priority of the first sidelink communication and the second request comprises a second priority of the second sidelink communication.

In other examples, the at least one prioritization rule includes a prioritization between a respective resource pool identifier (ID) associated with the first set of resources and the second set of resources or a respective carrier identity (ID) of a first carrier associated with the first set of resources and a second carrier associated with the second set of resources. In other examples, the at least one prioritization rule includes a prioritization between a respective zone identifier (ID) associated with the first request and the second request. In other examples, the at least one prioritization rule includes a prioritization between a respective communication direction of the first sidelink communication and the second sidelink communication. For example, the SL-RS prioritization circuitry 1244 shown and described above in connection with FIG. 12 may provide a means to select the selected SL-RS based on at least one prioritization rule.

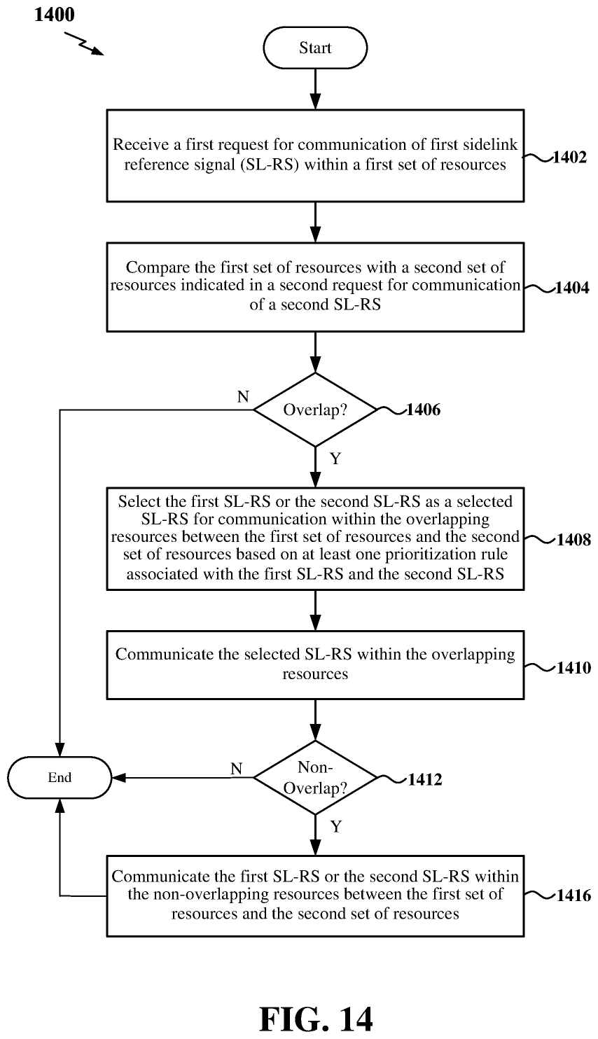

FIG. 14 is a flow chart 1400 of an exemplary method for SL-RS prioritization according to some aspects. As described below, some or all illustrated features may be omitted in a particular implementation within the scope of the present disclosure, and some illustrated features may not be required for implementation of all embodiments. In some examples, the method may be performed by the wireless communication device 1200, as described above and illustrated in FIG. 12, by a processor or processing system, or by any suitable means for carrying out the described functions.

At block 1402, the wireless communication device (e.g., a UE configured for sidelink communication) may receive a first request for communication of a first sidelink reference signal (SL-RS) within a first set of resources. For example, the first request may be received from a first device (e.g., another UE or a base station (e.g., via a relay UE)). For example, the communication and processing circuitry 1242 and transceiver 1210, shown and described above in connection with FIG. 12, may provide a means to receive the first request.

At block 1404, the wireless communication device may compare the first set of resources with a second set of resources indicated in a second request for communication of a second SL-RS. In some examples, the second request may be either received from a second device (e.g., UE or base station) or transmitted to the second device from the wireless communication device. For example, the SL-RS prioritization circuitry 1244, shown and described above in connection with FIG. 12, may provide a means to compare the first set of resources with the second set of resources.

At block 1406, the wireless communication device may determine whether the first set of resources at least partially overlaps the second set of resources in the time domain. For example, the SL-RS prioritization circuitry 1244 shown and described above in connection with FIG. 12 may provide a means to determine whether the first and second sets of resources at least partially overlap.

If the first and second sets of resources at least partially overlap (Y branch of block 1406), at block 1408, the wireless communication device may select the first SL-RS or the second SL-RS as a selected SL-RS for communication within the overlapping resources between the first set of resources and the second set of resources based on at least one prioritization rule associated with the first SL-RS and the second SL-RS. For example, the SL-RS prioritization circuitry 1244 shown and described above in connection with FIG. 12 may provide a means to select the selected SL-RS based on at least one prioritization rule.

At block 1410, the wireless communication device may communicate (e.g., transmit or receive) the selected SL-RS within the overlapping resources. For example, the communication and processing circuitry 1242 and transceiver 1210, shown and described above in connection with FIG. 12, may provide a means to communicate the selected SL-RS within the overlapping resources.

At block 1412, the wireless communication device may determine whether there are non-overlapping resources between the first and second sets of resources. In some examples, the first and second sets of resources may include different sets of symbols on which the first and second SL-RS are scheduled to be communicated. For example, the first set of resources may include at least one symbol that is not included in the second set of resources. For example, the SL-RS prioritization circuitry 1244 may provide a means to determine whether there are non-overlapping resources.

If there are non-overlapping resources between the first and second sets of resources (Y branch of block 1412), at block 1416, the wireless communication device may communicate (e.g., transmit or receive) the first SL-RS or the second SL-RS within the non-overlapping resources between the first set of resources and the second set of resources. For example, the communication and processing circuitry 1242 and transceiver 1210, shown and described above in connection with FIG. 12, may provide a means to communicate the first SL-RS or the second SL-RS within the non-overlapping resources.

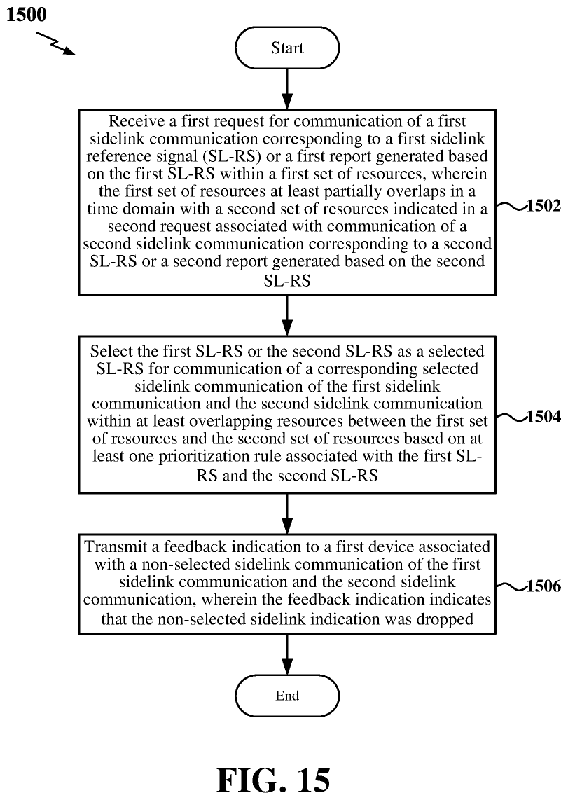

FIG. 15 is a flow chart 1500 of an exemplary method for SL-RS prioritization according to some aspects. As described below, some or all illustrated features may be omitted in a particular implementation within the scope of the present disclosure, and some illustrated features may not be required for implementation of all embodiments. In some examples, the method may be performed by the wireless communication device 1200, as described above and illustrated in FIG. 12, by a processor or processing system, or by any suitable means for carrying out the described functions.

At block 1502, the wireless communication device (e.g., a UE configured for sidelink communication) may receive a first request for communication of a first sidelink communication corresponding to a first sidelink reference signal (SL-RS) or a first report generated based on the first SL-RS within a first set of resources. The first set of resources may at least partially overlap in a time domain with a second set of resources indicated in a second request for communication of a second sidelink communication corresponding to a second SL-RS or a second report generated based on the second SL-RS. For example, the first request may be received from a first device (e.g., another UE or a base station (e.g., via a relay UE)) and the second request may either be received from a second device (e.g., UE or base station) or transmitted to the second device from the wireless communication device. For example, the communication and processing circuitry 1242 and transceiver 1210, shown and described above in connection with FIG. 12, may provide a means to receive the first request.

At block 1504, the wireless communication device may select the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS. For example, the SL-RS prioritization circuitry 1244 shown and described above in connection with FIG. 12 may provide a means to select the selected SL-RS based on at least one prioritization rule.

At block 1506, the wireless communication device may transmit a feedback indication to a first device associated with a non-selected sidelink communication of the first sidelink communication and the second sidelink communication. The feedback indication can indicate that the non-selected sidelink communication was dropped. In some examples, the feedback indication includes a negative acknowledgement (NACK) transmitted on a physical sidelink feedback channel (PSFCH) or a physical uplink control channel (PUCCH). In some examples, the feedback indication is transmitted on the PSFCH within a set of feedback resources based on a mapping between the set of feedback resources and a non-selected set of resources of the first set of resources and the second set of resources or a non-selected request of the first request and the second request associated with the non-selected sidelink communication.

In some examples, the wireless communication device may further transmit a second feedback indication to a second device associated with the selected sidelink communication. The second feedback indication can include an acknowledgement (ACK) of the selected sidelink communication. For example, the feedback circuitry 1246, together with the communication and processing circuitry 1242 and transceiver 1210, shown and described above in connection with FIG. 12 may provide a means to transmit the feedback indication.

In one configuration, the wireless communication device 1200 includes means for receiving for communication of a first sidelink communication corresponding to a first sidelink reference signal (SL-RS) or a first report generated based on the first SL-RS within a first set of resources, where the first set of resources at least partially overlaps in a time domain with a second set of resources indicated in a second request associated with communication of a second sidelink communication corresponding to a second SL-RS or a second report generated based on the second SL-RS, as described in the present disclosure. The wireless communication device 1200 further includes means for selecting the first SL-RS or the second SL-RS as a selected SL-RS for communication of a corresponding selected sidelink communication of the first sidelink communication and the second sidelink communication for communication within at least overlapping resources between the first set of resources and the second set of resources based on at least one prioritization rule associated with the first SL-RS and the second SL-RS. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 3, 4, 6, 9, and/or 11, and utilizing, for example, the processes and/or algorithms described herein in relation to FIGS. 13-15.

The processes shown in FIGS. 13-15 may include additional aspects, such as any single aspect or any combination of aspects described below and/or in connection with one or more other processes described elsewhere herein.

Aspect 1: A method for wireless communication at a wireless communication device in a wireless communication network, the method comprising: receiving a first request for communication of a first sidelink communication corresponding to a first sidelink reference signal (SL-RS) or a first report generated based on the first SL-RS within a first set of resources, wherein the first set of resources at least partially overlaps in a time domain with a second set of resources indicated in a second request for communication of a second sidelink communication corresponding to a second SL-RS or a second report generated based on the second SL-RS; and selecting the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS.

Aspect 2: The method of aspect 1, wherein the at least one prioritization rule comprises a prioritization between a respective timing behavior of the first sidelink communication and the second sidelink communication, wherein the timing behavior comprises periodic, semi-persistent, or aperiodic.

Aspect 3: The method of aspect 1 or 2, wherein the at least one prioritization rule comprises a prioritization between a respective time of communication of each of the first request and the second request.

Aspect 4: The method of any of aspects 1 through 3, wherein the at least one prioritization rule comprises a prioritization between a respective cast type of a respective sidelink associated with the first request and the second request, wherein the cast type comprises unicast, broadcast or groupcast.

Aspect 5: The method of any of aspects 1 through 4, wherein the at least one prioritization rule comprises a prioritization between a respective reference signal type of the first SL-RS and the second SL-RS.

Aspect 6: The method of any of aspects 1 through 5, wherein the at least one prioritization rule comprises a prioritization between a first report type of the first report to be generated based on the first SL-RS and a second report type of the second report to be generated based on the second SL-RS or a first transmission time of the first report and a second transmission time of the second report.

Aspect 7: The method of any of aspects 1 through 6, wherein the at least one prioritization rule comprises a prioritization between a respective first number of resources associated with the first request and the second request or a respective second number of resources associated with the first set of resources and the second set of resources.

Aspect 8: The method of any of aspects 1 through 7, wherein the at least one prioritization rule comprises a prioritization between a respective source identity (ID) associated with the first request and the second request or a respective sidelink resource allocation mode associated with the first request and the second request.

Aspect 9: The method of any of aspects 1 through 8, wherein the at least one prioritization rule comprises a prioritization between a respective first priority of each of the first sidelink communication and the second sidelink communication or a respective second priority associated with a first sidelink on which the first sidelink communication is communicated and a second sidelink on which the second sidelink communication is communicated.

Aspect 10: The method of aspect 9, wherein the first request comprises a first priority of the first sidelink communication and the second request comprises a second priority of the second sidelink communication.

Aspect 11: The method of any of aspects 1 through 10, wherein the at least one prioritization rule comprises a prioritization between a respective resource pool identifier (ID) associated with the first set of resources and the second set of resources or a respective carrier identity (ID) of a first carrier associated with the first set of resources and a second carrier associated with the second set of resources.

Aspect 12: The method of any of aspects 1 through 11, wherein the at least one prioritization rule comprises a prioritization between a respective zone identifier (ID) associated with the first request and the second request.

Aspect 13: The method of any of aspects 1 through 12, wherein the at least one prioritization rule comprises a prioritization between a respective communication direction of the first sidelink communication and the second sidelink communication.

Aspect 14: The method of any of aspects 1 through 13, wherein the selected sidelink communication comprises one of the first SL-RS or the second SL-RS, and further comprising: communicating the selected sidelink communication within the overlapping resources; and communicating the first SL-RS or the second SL-RS within non-overlapping resources between the first set of resources and the second set of resources.

Aspect 15: The method of any of aspects 1 through 14, further comprising: transmitting a first feedback indication to a first device associated with a non-selected sidelink communication of the first sidelink communication and the second sidelink communication, wherein the first feedback indication indicates that the non-selected sidelink communication was dropped.

Aspect 16: The method of aspect 15, wherein the transmitting the first feedback indication comprises: transmitting the first feedback indication comprising a negative acknowledgement on a physical sidelink feedback channel (PSFCH) or a physical uplink control channel (PUCCH).

Aspect 17: The method of aspect 16, wherein the transmitting the first feedback indication comprising the negative acknowledgement on the PSFCH or the PUCCH further comprises: transmitting the first feedback indication on the PSFCH within a set of feedback resources based on a mapping between the set of feedback resources and a non-selected set of resources of the first set of resources and the second set of resources or a non-selected request of the first request and the second request associated with the non-selected sidelink communication.

Aspect 18: The method of any of aspects 15 through 17, further comprising: transmitting a second feedback indication to a second device associated with the selected sidelink communication, wherein the second feedback indication comprises an acknowledgement of the selected sidelink communication.

Aspect 19: An apparatus in a wireless communication network comprising a transceiver, a memory, and a processor coupled to the transceiver and the memory, the processor and the memory configured to perform a method of any one of aspects 1 through 18.

Aspect 20: An apparatus in a wireless communication network comprising means for performing a method of any one of aspects 1 through 18.

Aspect 21: An article of manufacture comprising a non-transitory computer-readable medium having stored therein instructions executable by one or more processors of an apparatus to perform a method of any one of aspects 1 through 18.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-15 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 4, 6, 9, 11 and/or 12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication at a wireless communication device in a wireless communication network, the method comprising:
receiving a first request for communication of a first sidelink communication corresponding to a first sidelink reference signal (SL-RS) or a first report generated based on the first SL-RS within a first set of resources, wherein the first set of resources at least partially overlaps in a time domain with a second set of resources indicated in a second request for communication of a second sidelink communication corresponding to a second SL-RS or a second report generated based on the second SL-RS; and
selecting the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS.

2. The method of claim 1, wherein the at least one prioritization rule comprises a prioritization between a respective timing behavior of the first sidelink communication and the second sidelink communication, wherein the timing behavior comprises periodic, semi-persistent, or aperiodic.

3. The method of claim 1, wherein the at least one prioritization rule comprises a prioritization between a respective time of communication of each of the first request and the second request.

4. The method of claim 1, wherein the at least one prioritization rule comprises a prioritization between a respective cast type of a respective sidelink associated with the first request and the second request, wherein the cast type comprises unicast, broadcast or groupcast.

5. The method of claim 1, wherein the at least one prioritization rule comprises a prioritization between a respective reference signal type of the first SL-RS and the second SL-RS.

6. The method of claim 1, wherein the at least one prioritization rule comprises a prioritization between a first report type of the first report to be generated based on the first SL-RS and a second report type of the second report to be generated based on the second SL-RS or a first transmission time of the first report and a second transmission time of the second report.

7. The method of claim 1, wherein the at least one prioritization rule comprises a prioritization between a respective first number of resources associated with the first request and the second request or a respective second number of resources associated with the first set of resources and the second set of resources.

8. The method of claim 1, wherein the at least one prioritization rule comprises a prioritization between a respective source identity (ID) associated with the first request and the second request or a respective sidelink resource allocation mode associated with the first request and the second request.

9. The method of claim 1, wherein the at least one prioritization rule comprises a prioritization between a respective first priority of each of the first sidelink communication and the second sidelink communication or a respective second priority associated with a first sidelink on which the first sidelink communication is communicated and a second sidelink on which the second sidelink communication is communicated.

10. The method of claim 9, wherein the first request comprises a first priority of the first sidelink communication and the second request comprises a second priority of the second sidelink communication.

11. The method of claim 1, wherein the at least one prioritization rule comprises a prioritization between a respective resource pool identifier (ID) associated with the first set of resources and the second set of resources or a respective carrier identity (ID) of a first carrier associated with the first set of resources and a second carrier associated with the second set of resources.

12. The method of claim 1, wherein the at least one prioritization rule comprises a prioritization between a respective zone identifier (ID) associated with the first request and the second request.

13. The method of claim 1, wherein the at least one prioritization rule comprises a prioritization between a respective communication direction of the first sidelink communication and the second sidelink communication.

14. The method of claim 1, wherein the selected sidelink communication comprises one of the first SL-RS or the second SL-RS, and further comprising:
communicating the selected sidelink communication within the overlapping resources; and
communicating the first SL-RS or the second SL-RS within non-overlapping resources between the first set of resources and the second set of resources.

15. The method of claim 1, further comprising:
transmitting a first feedback indication to a first device associated with a non-selected sidelink communication of the first sidelink communication and the second sidelink communication, wherein the first feedback indication indicates that the non-selected sidelink communication was dropped.

16. The method of claim 15, wherein the transmitting the first feedback indication comprises:
transmitting the first feedback indication comprising a negative acknowledgement on a physical sidelink feedback channel (PSFCH) or a physical uplink control channel (PUCCH).

17. The method of claim 16, wherein the transmitting the first feedback indication comprising the negative acknowledgement on the PSFCH or the PUCCH further comprises:
transmitting the first feedback indication on the PSFCH within a set of feedback resources based on a mapping between the set of feedback resources and a non-selected set of resources of the first set of resources and the second set of resources or a non-selected request of the first request and the second request associated with the non-selected sidelink communication.

18. The method of claim 15, further comprising:
transmitting a second feedback indication to a second device associated with the selected sidelink communication, wherein the second feedback indication comprises an acknowledgement of the selected sidelink communication.

19. A wireless communication device in a wireless communication network, comprising:
a transceiver;
a memory; and
a processor coupled to the transceiver and the memory, wherein the processor and the memory are configured to:
receive a first request via the transceiver for communication of a first sidelink communication corresponding to a first sidelink reference signal (SL-RS) or a first report generated based on the first SL-RS within a first set of resources, wherein the first set of resources at least partially overlaps in a time domain with a second set of resources indicated in a second request for communication of a second sidelink communication corresponding to a second SL-RS or a second report generated based on the second SL-RS; and
select the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first SL-RS and the second SL-RS.

20. The wireless communication device of claim 19, wherein the selected sidelink communication comprises one of the first SL-RS or the second SL-RS, and wherein the processor and the memory are further configured to:
communicate the selected sidelink communication within the overlapping resources; and
communicate the first SL-RS or the second SL-RS within non-overlapping resources between the first set of resources and the second set of resources.

21. The wireless communication device of claim 19, wherein the processor and the memory are further configured to:
transmit a first feedback indication to a first device associated with a non-selected sidelink communication of the first sidelink communication and the second sidelink communication, wherein the first feedback indication indicates that the non-selected sidelink communication was dropped.

22. The wireless communication device of claim 21, wherein the processor and the memory are further configured to:
transmit the first feedback indication comprising a negative acknowledgement on a physical sidelink feedback channel (PSFCH) or a physical uplink control channel (PUCCH).

23. The wireless communication device of claim 22, wherein the processor and the memory are further configured to:
transmit the first feedback indication on the PSFCH within a set of feedback resources based on a mapping between the set of feedback resources and a non-selected set of resources of the first set of resources and the second set of resources or a non-selected request of the first request and the second request associated with the non-selected sidelink communication.

24. The wireless communication device of claim 21, wherein the processor and the memory are further configured to:
transmit a second feedback indication to a second device associated with the selected sidelink communication, wherein the second feedback indication comprises an acknowledgement of the selected sidelink communication.

25. A wireless communication device, comprising:
means for receiving a first request for communication of a first sidelink communication corresponding to a first sidelink reference signal (SL-RS) or a first report generated based on the first SL-RS within a first set of resources, wherein the first set of resources at least partially overlaps in a time domain with a second set of resources indicated in a second request for communication of a second sidelink communication corresponding to a second SL-RS or a second report; and
means for selecting the first SL-RS or the second SL-RS as a selected SL-RS for communication of a corresponding selected sidelink communication of the first sidelink communication and the second sidelink communication within at least overlapping resources between the first set of resources and the second set of resources based on at least one prioritization rule associated with the first sidelink communication and the second sidelink communication.

26. The wireless communication device of claim 25, wherein the selected sidelink communication comprises one of the first SL-RS or the second SL-RS, and further comprising:
means for communicating the selected sidelink communication within the overlapping resources; and
means for communicating the first SL-RS or the second SL-RS within non-overlapping resources between the first set of resources and the second set of resources.

27. The wireless communication device of claim 25, further comprising:
means for transmitting a first feedback indication to a first device associated with a non-selected sidelink communication of the first sidelink communication and the second sidelink communication, wherein the first feedback indication indicates that the non-selected sidelink communication was dropped.

28. The wireless communication device of claim 27, wherein the means for transmitting the first feedback indication comprises:
means for transmitting the first feedback indication comprising a negative acknowledgement on a physical sidelink feedback channel (PSFCH) or a physical uplink control channel (PUCCH).

29. The wireless communication device of claim 28, wherein the means for transmitting the first feedback indication comprising the negative acknowledgement on the PSFCH or the PUCCH further comprises:
means for transmitting the first feedback indication on the PSFCH within a set of feedback resources based on a mapping between the set of feedback resources and a non-selected set of resources of the first set of resources and the second set of resources or a non-selected request of the first request and the second request associated with the non-selected sidelink communication.

30. The wireless communication device of claim 27, further comprising:
means for transmitting a second feedback indication to a second device associated with the selected sidelink communication, wherein the second feedback indication comprises an acknowledgement of the selected sidelink communication.
